(19) United States
(12) Patent Application Publication
(10) Pub. No.: US 2009/0118864 A1
(43) Pub. Date: May 7, 2009

(54) METHOD AND SYSTEM FOR FINDING A TOOL CENTER POINT FOR A ROBOT USING AN EXTERNAL CAMERA

(76) Inventors: Bryce Eldridge, Fort Collins, CO (US); Steven G. Carey, Bellvue, CO (US); Lance F. Guymon, Fort Collins, CO (US)

Correspondence Address: COCHRAN FREUND & YOUNG LLC, 2026 CARIBOU DR, SUITE 201, FORT COLLINS, CO, 80525, US

(21) Appl. No.: 12/264,159

(22) Filed: Nov. 3, 2008

Related U.S. Application Data
(60) Provisional application No. 60/984,686, filed on Nov. 1, 2007.

(51) Int. Cl. B25J 13/08; B25J 19/04

(52) U.S. Cl. 700/259; 901/42; 901/47; 901/29

(57) ABSTRACT

Disclosed is a method and system for finding a relationship between a tool-frame of a tool attached at a wrist of a robot and robot kinematics of the robot using an external camera. The position and orientation of the wrist of the robot define a wrist-frame for the robot that is known. The relationship of the tool-frame and/or the Tool Center Point (TCP) of the tool is initially unknown. For an embodiment, the camera captures an image of the tool. An appropriate point on the image is designated as the TCP of the tool. The robot is moved such that the wrist is placed into a plurality of poses. Each pose of the plurality of poses is constrained such that the TCP point on the image falls within a specified geometric constraint (e.g. a point or a line). A TCP of the tool relative to the wrist frame of the robot is calculated as a function of the specified geometric constraint and as a function of the position and orientation of the wrist for each pose of the plurality of poses. An embodiment may define the tool-frame relative to the wrist frame as the calculated TCP relative to the wrist frame. Other embodiments may further refine the calibration of the tool-frame to account for tool orientation and possibly for a tool operation direction. An embodiment may calibrate the camera using a simplified extrinsic technique that obtains the extrinsic parameters of the calibration, but not other calibration parameters.

### CROSS REFERENCE TO RELATED APPLICATIONS

This application is based upon and claims priority to: U.S. provisional application Ser. No. 60/984,686, filed Nov. 1, 2007, entitled “A System and Method for Vision-Based Tool Calibration for Robots,” which is specifically incorporated herein by reference for all that it discloses and teaches.

### BACKGROUND OF THE INVENTION

In the early days of using robots for automated manufacturing, robot tasks were programmed by manually teaching the robot where to go. While manufacturing tasks remained of the relatively simple pick-and-place type, this method of robot programming was adequate because the number of robot poses required was small. However, as the complexity of automated systems increased, so did the need for a higher-level type of programming. The concept of offline programming arose, which basically means that instead of manually recording joint angles for each desired position, a high level task description may be specified, and then automatically translated into a set of joint angles in order to accomplish the desired task. In order to go from task space to joint space, a mathematical (i.e., kinematic) model for the robot was used.

### SUMMARY OF THE INVENTION

An embodiment of the present invention may comprise a method for vision-based calibration of a tool-frame for a tool attached to a robot using a camera comprising: providing the robot, the robot having a wrist that is moveable, the robot having a control system that moves the robot and the wrist into different poses, the tool attached to the robot being at different orientations for the different poses, the robot control system defining a wrist-frame for the wrist of the robot such that the robot control system knows a position and an orientation of the wrist for the different poses via a kinematic model of the robot; providing the camera, the camera being mounted external of the robot, the camera capturing an image of the tool; designating a point on the tool in the image of the tool as an image tool center point of the tool, the image tool center point being a point on the tool that is desired to be an origin of the tool-frame for the kinematic model of the robot; moving the robot into a plurality of wrist poses, each wrist pose of the plurality of wrist poses being constrained such that the image tool center point of the tool is located within a specified geometric constraint in the image captured by the camera; calculating a tool-frame tool center point relative to the wrist-frame of the wrist of the robot for the tool as a function of the specified geometric constraint and also as a function of the position and the orientation of the wrist of the robot for each wrist pose of the plurality of wrist poses; defining the tool-frame of the tool relative to the wrist-frame for the kinematic model of the robot as the tool-frame tool center point; and, operating the robot to perform desired tasks with the tool using the kinematic model of the robot with the defined tool-frame.

An embodiment of the present invention may further comprise a vision-based robot calibration system for calibrating a tool-frame for a tool attached to a robot using a camera comprising: the robot, the robot having a wrist that is moveable, the robot having a control system that moves the robot and the wrist into different poses, the tool attached to the robot being at different orientations for the different poses, the robot control system defining a wrist-frame for the wrist of the robot such that the robot control system knows a position and an orientation of the wrist for the different poses via a kinematic model of the robot; the camera, the camera being mounted external of the robot, the camera capturing an image of the tool; a wrist pose sub-system that designates a point on the tool in the image of the tool as an image tool center point of the tool and moves the robot into a plurality of wrist poses, the image tool center point being a point on the tool that is desired to be an origin of the tool-frame for the kinematic model of the robot, each wrist pose of the plurality of wrist poses being constrained such that the image tool center point of the tool is located within a specified geometric constraint in the image captured by the camera; a tool center point calculation sub-system that calculates a tool-frame tool center point relative to the wrist-frame of the wrist of the robot for the tool as a function of the specified geometric constraint and also as a function of the position and the orientation of the wrist of the robot for each wrist pose of the plurality of wrist poses; a robot kinematic incorporation subsystem that defines the tool-frame of the tool relative to the wrist-frame for the kinematic model of the robot as the tool-frame tool center point.

An embodiment of the present invention may further comprise a vision-based robot calibration system for calibrating a tool-frame for a tool attached to a robot using a camera comprising: means for providing the robot, the robot having a wrist that is moveable, the robot having a control system that moves the robot and the wrist into different poses, the robot control system defining a wrist-frame for the wrist of the robot such that the robot control system knows a position and an orientation of the wrist for the different poses via a kinematic model of the robot; means for providing the camera, the camera being mounted external of the robot, the camera capturing an image of the tool; means for designating a point on the tool in the image of the tool as an image tool center point of the tool; means for moving the robot into a plurality of wrist poses, each wrist pose of the plurality of wrist poses being constrained such that the image tool center point of the tool is located within a specified geometric constraint in the image captured by the camera; means for calculating a tool-frame tool center point relative to the wrist-frame of the wrist of the robot for the tool as a function of the specified geometric constraint and also as a function of the position and the orientation of the wrist of the robot for each wrist pose of the plurality of wrist poses; means for defining the tool-frame of the tool relative to the wrist-frame for the kinematic model of the robot as the tool-frame tool center point; and, means for operating the robot to perform desired tasks with the tool using the kinematic model of the robot with the defined tool-frame.

An embodiment of the present invention may further comprise a computerized method for calculating a tool-frame tool center point relative to a wrist-frame of a robot for a tool attached at a wrist of the robot using a camera comprising: providing a computer system for running computer software, the computer system having at least one computer readable storage medium for storing data and computer software; mounting the camera external of the robot; operating the camera to capture an image of the tool; defining a point on a geometry of the tool as a tool center point of the tool; defining a constraint region on the image captured by the camera; moving the robot into a plurality of wrist poses, each wrist pose of the plurality of wrist poses having a known position and orientation within a kinematic model of the robot; each wrist pose of the plurality of wrist poses having a different position and orientation from other wrist poses of the plurality of wrist poses; analyzing the image captured by the camera with the computer software to locate the tool center point of the tool in the image for each wrist pose of the plurality of wrist poses; correcting the position and orientation of each wrist pose of the plurality of wrist poses using the camera such that the tool center point of the tool located in the image captured by the camera is constrained within the constraint region defined for the image; calculating a tool-frame tool center point relative to the wrist-frame of the robot with the computer software as a function of the position and orientation of each wrist pose of the plurality of wrist poses as corrected to constrain the tool center point in the image to the constraint region on the image; updating the kinematic model of the robot with the computer software to incorporate the tool-frame tool center point relative to the wrist-frame of the robot as an origin of the tool-frame of the tool within the kinematic model of the robot; and, operating the robot using the kinematic model as updated to incorporate the tool-frame tool center point to perform desired tasks with the tool.

An embodiment of the present invention may further comprise a computerized calibration system for calculating a tool-frame tool center point relative to a wrist-frame of a robot for a tool attached at a wrist of the robot using an externally mounted camera comprising: a computer system that runs computer software, the computer system having at least one computer readable storage medium for storing data and computer software; operating the camera to capture an image of the tool; a constraint definition sub-system that defines a point on a geometry of the tool as a tool center point of the tool and defines a constraint region on the image captured by the camera; a wrist pose sub-system that moves the robot into a plurality of wrist poses, each wrist pose of the plurality of wrist poses having a known position and orientation within a kinematic model of the robot; each wrist pose of the plurality of wrist poses having a different position and orientation from other wrist poses of the plurality of wrist poses; an image analysis sub-system that analyzes the image captured by the camera with the computer software to locate the tool center point of the tool in the image for each wrist pose of the plurality of wrist poses; a wrist pose correction sub-system that corrects the position and orientation of each wrist pose of the plurality of wrist poses using the camera such that the tool center point of the tool located in the image captured by the camera is constrained within the constraint region defined for the image; a tool-frame tool center point calculation sub-system that calculates a tool-frame tool center point relative to the wrist-frame of the robot with the computer software as a function of the position and orientation of each wrist pose of the plurality of wrist poses as corrected to constrain the tool center point in the image to the constraint region on the image; and, a kinematic model update sub-system that updates the kinematic model of the robot with the computer software to incorporate the tool-frame tool center point relative to the wrist-frame of the robot as an origin of the tool-frame of the tool within the kinematic model of the robot.

An embodiment of the present invention may further comprise a robot calibration system that finds a tool-frame tool center point relative to a wrist-frame of a tool attached to a robot using an externally mounted camera comprising a computer system programmed to: analyze an image captured by the externally mounted camera to locate a point on the tool in the image designated as an image tool center point of the tool for each wrist pose of a plurality of wrist poses of the robot, each wrist pose of the plurality of wrist poses being constrained such that the image tool center point is constrained within a geometric constraint region on the image, each wrist pose of the plurality of wrist poses having a known position and orientation within a kinematic model of the robot, each wrist pose of the plurality of wrist poses having a different position and orientation within the kinematic model of the robot from other wrist poses of the plurality of wrist poses; calculate the tool-frame tool center point relative to the wrist-frame of the robot as a function of the position and orientation of each wrist pose of the plurality of wrist poses; update the kinematic model of the robot to incorporate the tool-frame tool center point relative to the wrist-frame of the robot as an origin of the tool-frame of the tool within the kinematic model of the robot; and, deliver the updated kinematic model of the robot to the robot such that the robot operates using the updated kinematic model to perform desired tasks with the tool attached to the robot.

### BRIEF DESCRIPTION OF THE DRAWINGS

In the drawings,

FIG. 1 is an illustration of coordinate frames defined for a robot/robot manipulator as part of a kinematic model of the robot.

FIG. 2 is an illustration of an overview of vision-based Tool Center Point (TCP) calibration for an embodiment.

FIG. 3 is an illustration of two wrist poses for a three-dimensional TCP point constraint.

FIG. 4 is an illustration of the condition for a TCP line geometric constraint that lines connecting pairs of points are parallel.

FIG. 5 is an illustration of example wrist poses for a TCP line geometric constraint.

FIG. 6 is an illustration of a calibration for tool operation direction for a two-wire welding torch.

FIG. 7 is an illustration of the pinhole camera model for camera calibration.

FIG. 8A is an example camera calibration image for a first orientation of a checkerboard camera calibration device.

FIG. 8B is an example camera calibration image for a second orientation of a checkerboard camera calibration device.

FIG. 8C is an example camera calibration image for a third orientation of a checkerboard camera calibration device.

FIG. 9A is an example image of a first type of a Metal-Inert Gas (MIG) welding torch tool.

FIG. 9B is an example image of a second type of a MIG welding torch tool.

FIG. 9C is an example image of a third type of a MIG welding torch tool.

FIG. 10A is an example image of an original image captured in a process for locating a TCP of a tool on the camera image.

FIG. 10B is an example image of the thresholded image created as part of the sub-process of segmenting the original image in the process for locating the TCP of the tool on the camera image.

FIG. 10C is an example image of the convex hull image created as part of the sub-process of segmenting the original image in the process for locating the TCP of the tool on the camera image.

FIG. 11A is an example image showing the sub-process of finding a rough orientation of the tool by fitting an ellipse around the convex hull image in the process for locating the TCP of the tool on the camera image.

FIG. 11B is an example image showing the sub-process of refining the orientation of the tool by searching for the sides of the tool in the process for locating the TCP of the tool on the camera image.

FIG. 11C is an example image showing the sub-process of searching for the TCP at the end of tool in the overall process for locating the TCP of the tool on the camera image.

FIG. 12 is an illustration of visual servoing used to ensure that the tool TCP reaches a desired point in the camera image.

FIG. 13 is an illustration of a process to automatically generate wrist poses for a robot.

FIG. 14 is an illustration of homogenous difference matrix properties for a point constraint.

FIG. 15 is an illustration of an example straight line fitting for three-dimensional points of a Singular Value Decomposition (SVD for least-squares fitting.

### DETAILED DESCRIPTION OF THE EMBODIMENTS

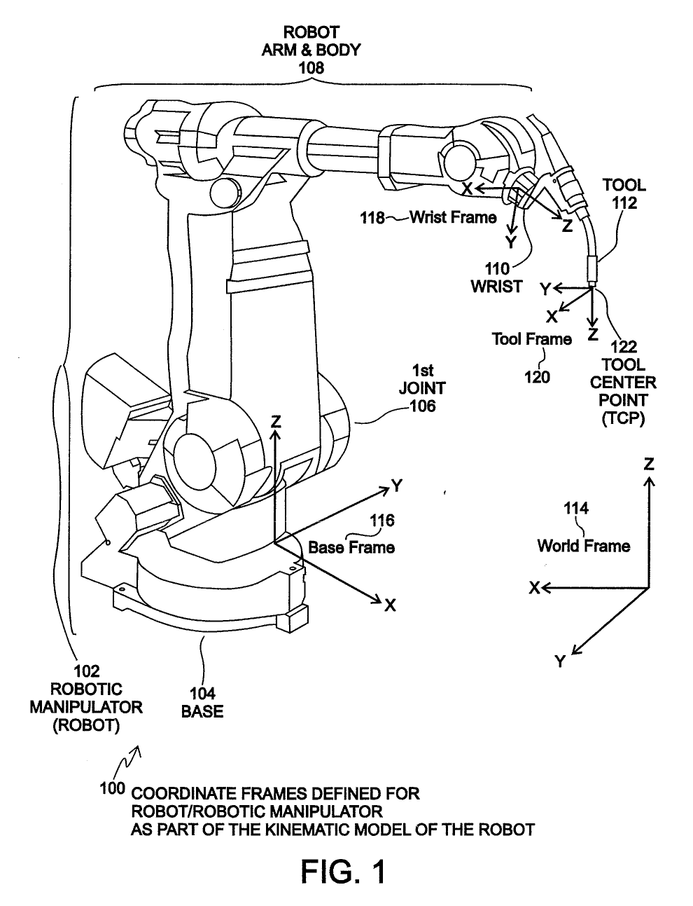

FIG. 1 is an illustration 100 of coordinate frames 114-120 defined for a robot/robot manipulator 102 as part of a kinematic model of the robot 102. In a simple form, an industrial robot may be comprised of a robot manipulator 102, power supply, and controllers. Since the power supply and controllers of a robot are not typically illustrated as part of the mechanical assembly of the robot, the robot and robot manipulator 102 are often referred to as the same object since the most recognizable part of a robot is the robot manipulator 102. The robot manipulator is typically made up of two sub-sections, the body and arm 108 and the wrist 110. A tool 112 used by a robot 102 to perform desired tasks is typically attached at the wrist 110 of the robot manipulator 102. A large number of industrial robots 102 are six-axis rotary joint arm type robots. The actual configuration of each robot 102 varies widely depending on the task the robot 102 is intended to perform, but the basic kinematics are typically the same. For a six-axis rotary joint arm type of robot 102, the joint space is usually the six-dimensional space (i.e., position of each joint) of all possible joint angles that a robot controller of the robot uses to position the robotic manipulator 102. A vector in the joint space may represent a set of joint angles for a given pose, and the angular ranges of the joints of the robot 102 may determine the boundaries of the joint space. The task space typically corresponds to the three-dimensional world 114. A vector in the task space is usually a six-dimensional entity describing both the position and orientation of an object. The forward kinematics of the robot 102 may define the transformation from joint space to task space. Usually, however, the task is specified in task space, and a computer decides how to move the robot in order to accomplish the transformation from joint space to task space. The transformation is typically done via the inverse kinematics of the robot 102, which maps task space to joint space. Both the forward and inverse transformations depend on the kinematic model of the robot 102, which will typically differ from the physical system to some degree.

There are several important coordinate frames 114-120 that are usually defined for a robotic system 102. The world-frame 114 is typically defined somewhere in space, and does not necessarily correspond to any physical feature of the robot 102 or of the work cell. The base-frame 116 of the robot 102 is typically centered at the base 104 of the robot 102, with the z-axis of the base-frame 116 pointing along the first joint 106 axis. The wrist-frame 118 of the robot is typically centered at the last link (usually link 6) (aka. wrist 108). The relationship between the base-frame 116 and the wrist-frame 118 is typically determined through the kinematic model of the robot 102, which is usually handled inside the robot 102 controller software. The tool-frame 120 is typically specified with respect to the wrist-frame 116, and is usually defined with the origin 122 at the tip of the tool 112 and the z-axis along the tool 112 direction. The tool 112 direction may be somewhat arbitrary, and depends to a great extent on the type of tool 112 and the task at hand. The tool-frame 120 is typically a coordinate transformation between the wrist-frame 118 and the tool 112, and is sometimes called the tool offset. The three-dimensional (3-D) position of the origin 122 of the tool-frame 120 relative to the wrist-frame 118 is typically also called the tool center point (TCP) 122. Tool 112 calibration generally means computing both the position (TCP) 122 and orientation of the tool-frame 120.

A distinction is typically made between accuracy and repeatability in robot systems. Accuracy is the ability of the robot 102 to place its end effector (e.g., the tool 112) at a pre-determined point in space, regardless of whether that point has been reached before or not. Repeatability is the ability of the robot 102 to return to a previous pose. Usually a robot's 102 repeatability will be better than the robot's 102 accuracy. That is, the robot 102 can return to the same point every time, but that point may not be exactly the point that was specified in task space. Thus, it is likely better to use relative motions of the robot 102 for calibration instead of relying on absolute positioning accuracy.

As offline programming of industrial robotic systems has become more prevalent, the need for accurate calibration techniques for components in an industrial robot cell has increased. One of the factors required for successful offline programming is an accurate calibration of the robot's 102 tool-frame 120. Excessive errors in the calibration of the tool-frame 120 will result in tool positioning errors that may render the system useless. Methods for calibrating the tool-frame 120 typically are manual, time consuming, and often require a skilled operator. Various embodiments of the present invention are directed to a simple, fast, vision-based method and system for calibrating the tool-frame 120 of a robot 102, such as an industrial robot 102.

Usually in the case of kinematic calibration, which typically deals directly with identifying and compensating for errors in the robot's 102 kinematic model, the tool-frame 120 is either assumed to be known or is included as part of the full calibration procedure. A large number of tools 112, including welding and cutting tools, may not be capable of providing any information about the tool's 112 own position or orientation. In contrast, various embodiments offer a method of calibrating the tool-frame 120 quickly and accurately without including the kinematic parameters.

The tool-frame 120 calibration algorithm of the various embodiments offers several advantages. First, a vision-based method is very fast while still delivering excellent accuracy. Second, minimal calibration and setup is required. Third, the various embodiments are non-invasive (i.e., require no contact with the tool 112) and do not use special hardware other than a camera, enclosure, and associated image acquisition hardware. While vision-based methods are not appropriate for every situation, using them to calibrate the tool-frame 120 of an industrial robot offers a fast and accurate way of linking the offline programming environment to the real world.

In practice, the mathematical kinematic model of the robot 102 will invariably be different than the real manipulator 102. The differences cause unexpected behaviors and positioning errors. To help alleviate the unexpected behaviors and positioning errors, a variety of calibration techniques may be employed to refine and update the mathematical kinematic models used. The various calibration techniques attempt to identify and compensate for errors in the robotic system. The errors typically fall into two general categories. The first kind of error that occurs in robotic systems is geometric error, such as an incorrectly defined link length in the kinematic model. The second type of error is called non-geometric error, which may include temperature effects, gear backlash, loading, and the un-modeled dynamics of the robotic system. While both types of errors may have a significant effect on the positioning accuracy of the system, geometric errors are typically the easiest to identify and correct. Non-geometric errors may be difficult to compensate for, due to being linked to the basic mechanical structure of the robot and the possibility that some of the non-geometric errors may change rapidly and significantly during robot 102 operation (e.g., temperature effects, loading effects, etc.).

Robot 102 calibration is typically divided into four steps: selection of the kinematic model, measurement of the robot's 102 pose, identification of the model parameters, and compensation of robot 102 pose errors. The measurement phase is typically the most critical, and affects the result of the entire calibration. Many different devices have been used for the measurement phase, including Coordinate Measuring Machines (CMMs), theodolites, lasers, and visual sensors. Visual sensors, in particular Charge-Coupled Device (CCD) array cameras, have the advantage of being relatively inexpensive, flexible, and widely available. It is important to note that in order to use a camera as a measuring device, the camera may also need to be calibrated correctly.

Overall kinematic calibration of the robotic manipulator 102 is very important for positioning accuracy, and may include tool-frame 120 calibration. However, there may also be a need for independently calibrating the tool-frame 120, which arises from a number of sources. First, many robotic systems come with pre-calibrated kinematic models that do not include the actual tool 112 that will be used. Also, some commercial robot controllers do not allow access to the kinematic parameters, or modifying the kinematic parameters is beyond the expertise of the average robot user. Additionally, in some systems the tool 112 is often changed, or may be damaged or bent if the robot 102 crashes into a fixed object. For many applications (e.g., welding), it is critically important to have a good definition of the tool-frame 120. The method and system of the various embodiments provides for quick and accurate calibration of the tool-frame 120 without performing a full kinematic calibration of the robot 102 such that the tool-frame 120 is independently calibrated. The basic issue addressed by the various embodiments is, assuming that the wrist 110 pose in the world-frame 114 is correct, what is the position and orientation of the tool-frame 120 relative to the wrist 110? For the various embodiments, the wrist 110 pose is assumed to be accurate. The method of the various embodiments is generally concerned with computing an accurate tool-frame 120 relative to the wrist-frame 118, which means that the rest of the robot 102 pose may become irrelevant.

The remainder of the Detailed Description of the Embodiments is organized into five main sections. The first section deals with the methods used by various embodiments to calibrate the tool-frame 120 assuming that the wrist 110 position is correct. In particular, an analysis of the tool-frame 120 calibration problem and methods for tool-frame 120 calibration are described. The second section describes vision and camera calibration. The third section describes the application of a vision system to enforce a constraint on the tool so that the previously developed methods may be used for tool-frame calibration. The fourth section describes the results of simulations and testing with a real robotic system. The fifth section describes Appendices for supporting concepts including some properties of homogeneous difference matrices (Appendix A), as well as detailing the use of Singular Value Decomposition (SVD) for least-squares fitting (Appendix B).

Calibrating the Tool-Frame

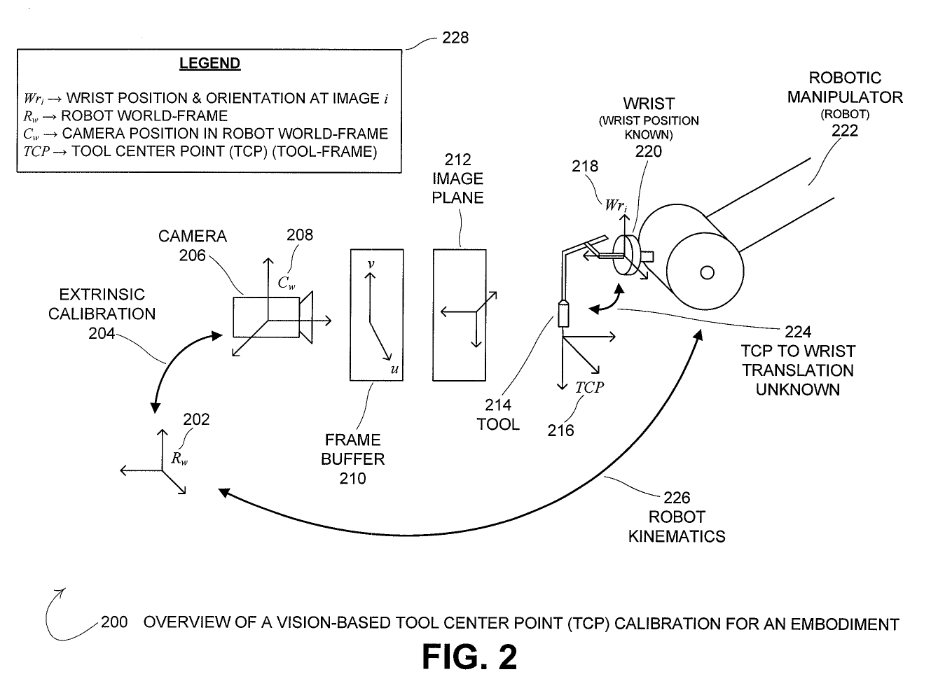

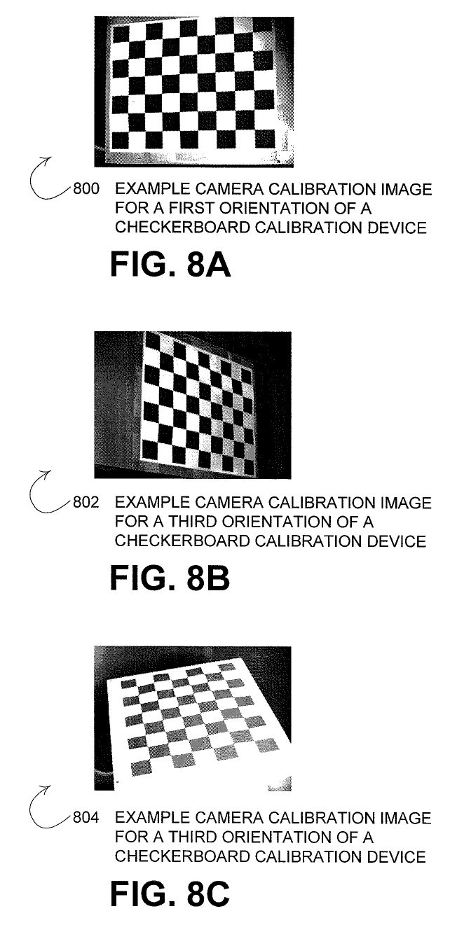

FIG. 2 is an illustration of an overview 200 of vision-based Tool Center Point (TCP) calibration for an embodiment. A legend 228 describes a variety of important reference frames 202, 206, 216, 218 shown in the overview 200. As shown in the overview 200, the robot's 222 world-frame of reference R_{w} 202 may need to be extrinsically calibrated 204 with the external camera's 206 camera-centered coordinate frame of reference C_{w} 208. The camera 206 may be modeled using a pinhole camera model such that the camera-centered coordinate frame of reference C_{w} 208 defines how points appear on the image plane 212 and scaling factors define how the image plane is mapped onto the pixel-based frame buffer 210. See the section on Vision Concepts below in the disclosure with respect to FIGS. 7 and 8 for a further description of camera 206 modeling and calibration 204. The robot kinematic model 226 provides the translation between the robot's 222 world-frame R_{w} 202 and the various wrist poses Wrᵢ 218 of the wrist 220 of the robot 222. Thus, the wrist 220 position and orientation for each potential wrist pose Wri is known via the kinematic model 226 of the robot 222. The tool 214 used by the robot 222 to perform desired tasks is typically attached at the last joint (aka. wrist) 220 of the robot. A first important relationship between the tool 214 and the robot 222 is the relationship between the Tool Center Point (TCP) 216 of the tool and the wrist 220 (i.e., wrist-frame) of the robot/robotic manipulator 222. For many applications (e.g., industrial welding), the translational relationship 224 between the TCP 216 of the tool 214 the wrist 220 is unknown in the kinematic model 226 of the robot 222. As described in detail below, a plurality of wrist poses Wrᵢ 218 with the wrist pose 218 position and orientation known via the robot kinematic model 226 may be obtained while constraining the TCP 216 of the tool 214 to remain within a specific geometric constraint (e.g., constraining the TCP to stay at a single point or to stay on a line) in order to permit an embodiment to calculate translational relationship 224 of the TCP 216 of the tool 214 relative 224 to the wrist 220 of the robot 222. The camera 206 is used to visually observe the tool 214 to enforce, and/or calculate a deviation from, the specified geometric constraint for the TCP of the tool for the plurality of wrist poses Wrᵢ 218.

Calibrating the tool-frame of the tool 214 may be divided into two separate stages. First the Tool Center Point (TCP) 216 is found. Next the orientation of the tool 214 relative to the wrist 220 may be computed if the TCP location is insufficient to properly model the tool. For some tools, a third calibration stage may be added to address properly situating the tool for an operation direction (e.g., a two-wire welding torch that should have the two wires aligned along a weld seam).

Tool-Frame Cal. Stage 1: Calibrating the Tool Center Point (TCP)

A technique is described below for computing the three-dimensional (3-D) vector from the origin of the wrist-frame to the origin of the tool-frame, given that the TCP 216 is physically constrained in the world-frame R_{w} 202. The specific constraints that are used are typically simple and geometric, including constraints that the TCP 216 be at a point or lie on a line. To say that the TCP 216 is physically constrained means that the wrist 220 of the robot will be moved to different poses Wrᵢ 218 while the TCP 214 remains at a point or on a line. This technique will work for any tool 214, as long as the TCP 216 location may be measured and the geometric constraint may be enforced. The calibration of the TCP 216 to the wrist 220 may be accomplished by a number of methods, including torque sensing, touch sensing, and visual sensing.

To calculate the TCP 216, something may need to be known about the position of the TCP 216 or the pose of the wrist Wrᵢ 218. For example, constraining the wrist 220 and measuring the movement of the TCP 216 would provide enough information to accomplish the tool-frame calibration. However, with the TCP as the variable in the calibration 224, it is assumed that nothing is known about the tool 214 before calibration 224. Modern robot 222 controllers allow full control of the position and orientation of the wrist 220, so it makes more sense to constrain the TCP 216 and use the full pose information of the wrist poses Wrᵢ 218 to calibrate 224 the TCP 216.

The problem of finding 224 the TCP 216 may be examined in both two and three dimensions (2-D and 3-D), although in practice the three-dimensional case is typically used. However, the two-dimensional case provides valuable insight into the problem. To discuss the two-dimensional TCP 216 calibration 224 problem, several variables must be defined. In two dimensions, the TCP 216 is denoted as in Eq. 1.

t=(tₓ t_{y} 1)^{T} Eq. 1

And in three dimensions the TCP 216 is denoted as in Eq. 2.

t=(tₓ t_{y} t_{z} 1)^{T} Eq. 2

Note that the vector t is specified with respect to the wrist 220 coordinate frame 218. Homogeneous coordinates are used so that the homogeneous transformation representation of the wrist-frames Wrᵢ 218 may be used. The i^{th} pose of the robot wrist-frame Wrᵢ 218 may be denoted as in Eq. 3.

$${W}_{i} ( \begin{matrix}{R}_{i} & {T}_{i} \\ 0 & 1\end{matrix} ) \\ i = 1 , … , N \qquad Eq . 3$$

Where Tᵢ is the translation from the origin of the world-frame R_{w} 202 to the origin of the i^{th} wrist-frame Wrᵢ 218, and Rᵢ is the rotation from the world-frame R_{w} 202 to the i^{th} wrist-frame Wrᵢ 218. In two dimensions the Wᵢ matrix is of size 3×3, while in three dimensions the Wᵢ matrix is of size 4×4. The i^{th} wrist-frame Wrᵢ 218 pose information is available from the kinematics 226 of the robot 222, which is computed in the robot controller.

The position pᵢ of the TCP 216 in the world coordinate system R_{w} 202 for the i^{th} wrist pose Wrᵢ 218 may be computed as in Eq. 4.

pᵢ=Wᵢt i=1, . . . , N Eq. 4

Where Wᵢ is the transformation from the i^{th} wrist-frame Wrᵢ 218 to the world coordinate frame R_{w} 202.

A point constraint means that the position of the TCP 216 in the world-frame R_{w} 202 is the same for each wrist pose Wrᵢ 218, as shown in Eqs. 5 and 6.

p₁=p₂= . . . =p_{N} Eq. 5

or

W₁t=W₂t= . . . =W_{N}t Eq. 6

Meaning that any two of the points pᵢ of the TCP 216 are equal as in Eq. 7.

Wᵢt−Wⱼt=(Wᵢ−Wⱼ)t=0 i≠j Eq. 7

To obtain information from a point constraint, at least two wrist poses Wrᵢ 218 are needed. If more than two wrist poses Wrᵢ 218 are available, the constraints may be stacked together into a matrix equation of the form shown in Eq. 8.

$$( \begin{matrix}{W}_{1} - {W}_{2} \\ {W}_{1} - {W}_{3} \\ ⋮ \\ {W}_{N - 1} - {W}_{N}\end{matrix} ) t = 0 \qquad Eq . 8$$

Where the matrix is called the constraint matrix and is denoted by A.

Stacking the constraints as in Eq. 8 prevents duplication while covering the possible combinations. In fact, each additional wrist pose Wrᵢ 218 provides an increasing number of constraints that may be used to increase accuracy when there are small errors in Wrᵢ 218 as may appear in a real world system. Because the order of the terms in each constraint is unimportant (i.e., W₁−W₂ is equivalent to W₂−W₁), the number of constraint equations, denoted M, may be determined as the number of combinations of wrist poses Wrᵢ 218 taken two at a time from the set of all available wrist poses Wrᵢ 218 as described in Eq. 9.

$$M = ( \begin{matrix}N \\ 2\end{matrix} ) = \frac{N !}{2 ( N - 2 ) !} \qquad Eq . 9$$

For example, when N=3, the number of constraints in Eq. 8 is shown in Eq. 10.

$$M = ( \begin{matrix}3 \\ 2\end{matrix} ) = \frac{3 !}{2 ( 3 - 2 ) !} = 3 \qquad Eq . 10$$

In Eq. 8, it may be seen that t is in the null space of the constraint matrix. Because t is specified in homogeneous coordinates, the last element of t must be equal to one. Therefore, as long as the dimension of the null space of the constraint matrix is less than or equal to one, the solution may be recovered by scaling the null space. If the dimension of the null space is zero, then t is the null vector of the constraint matrix. If the dimension of the null space is one, then t may be recovered by scaling the null vector of the constraint matrix so that the last element is equal to one.

To find the null space of the constraint matrix, the Singular Value Decomposition (SVD) may be used. Applying the SVD yields Eq. 11.

A=UΣV^{T} Eq. 11

Where Σ is a diagonal matrix containing the singular values of A. U and V contain the right and left singular directions of A, and the null space of A is the span of the right singular vectors corresponding to the singular values of A that are zero because the singular values represent the scaling of the matrix in the corresponding singular direction, and the null space contains all vectors that are scaled by zero. Note that in practice the minimum singular values will likely never be exactly zero, so the null space will be approximated by the span of the singular directions corresponding to the singular values of A that are close to zero.

Using the SVD to find the null space and then scaling the singular direction vector appropriately to recover t works as long as the dimension of the null space of the constraint matrix is less than or equal to one. It is clear that the dimension of the null space is related to the number of poses Wrᵢ 218 used to build the constraint matrix, and that a minimum number of poses Wrᵢ 218 will be required in order to guarantee that the dimension of the null space is less than or equal to one.

The minimum number of poses Wrᵢ 218 depends on the properties of the matrix that results from subtracting two homogeneous transformation matrices (see Appendix A section below). For convenience, the matrix resulting from subtracting two homogeneous transformation matrices will be called a homogeneous difference matrix. The constraint matrix is a composition of M of the homogeneous difference matrices. Because the Wᵢ's are homogeneous transformation matrices, the last row of each Wᵢ is (0, 0, . . . , 1)^{T}. Therefore, when two homogeneous transformation matrices are subtracted, the last row of the resulting matrix is zero as in Eq. 12.

$${W}_{i} - {W}_{j} = ( \begin{matrix}{R}_{i} - {R}_{j} & {T}_{i} - {T}_{j} \\ 0 & 0\end{matrix} ) i \neq j \qquad Eq . 12$$

It is clear that the matrix of Eq. 12 will not be of full rank. For example, in the two-dimensional case, with two wrist poses Wrᵢ 218, the dimension of the constraint matrix is 3×3, but the maximum rank of the matrix of Eq. 12 is two. However, it turns out that the rank of the constraint matrix in the case of Eq. 12 is always two as long as the two wrist poses Wrᵢ 218 have different orientations, which means that the dimension of the null space is guaranteed to be at least one. Therefore, the minimum number of wrist poses Wrᵢ 218 to obtain a unique solution for t in the two-dimensional point constraint case is two.

In the three-dimensional point constraint case the situation is more complicated. For two wrist poses Wrᵢ 218, the dimension of the constraint matrix is now 4×4. The last row of the constraint matrix is zero, as in the two-dimensional point constraint case. Therefore, the rank of the constraint matrix cannot be more than three. However, the rank of the constraint matrix is in fact only two, because all four columns in the three-dimensional homogeneous difference matrix are coplanar. To help understand, first note that Property A2 (see Appendix A section below) states that the vectors in the upper left 3×3 block of the difference matrix are coplanar. To show that the fourth column is contained in the same plane, it is helpful to draw a picture.

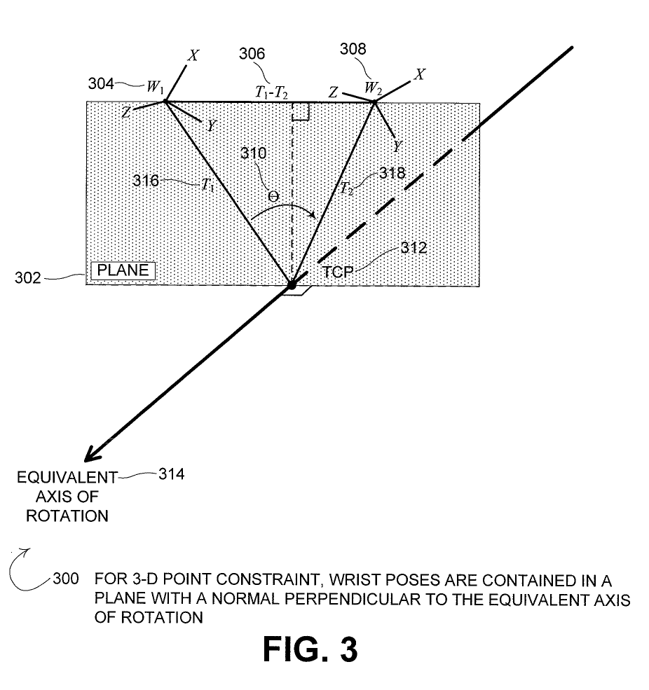

FIG. 3 is an illustration of two wrist poses 304, 308 for a three-dimensional TCP 312 point constraint. The vector between the origins of the wrist poses 304, 308, T₁-T₂ 306, is perpendicular to the equivalent axis of rotation 314. The wrist poses W₁ 304 and W₂ 308 are rotated through angle θ 310 such that rotational vectors T₁ 316 and T₂ 318 translate W₁ 304 and W₂ 308, respectively, to the TCP 312. Another way to say this is that when the TCP 312 is rotated (i.e., moved by angle θ 310) about the equivalent axis of rotation 314, the TCP 312 moves in a plane 302. The equivalent axis of rotation 314 is normal to the plane of rotation 302. To get the point constraint, the TCP 312 frame must then be translated in the same plane 302 meaning that T₁-T₂ 306 is contained in the same plane as the rotational difference vectors 316, 318. Therefore, only two of the columns of Wᵢ-Wⱼ are linearly independent, so for two wrist poses, the dimension of the null space of the constraint matrix is two. Note that the preceding relationship is only valid for a point constraint. For a line constraint, T₁-T₂ 306 is not guaranteed to be in the same plane 302 as the rotational component of the homogeneous difference matrix.

Because t is specified in homogeneous coordinates, any vector in the null space may be scaled so that the last element is one, which reduces the solution space to a line instead of a plane. However, reducing the solution space to a line is still insufficient to determine a unique solution for t, meaning that an additional wrist pose is needed. Adding a third wrist pose increases M to three, and increases the dimension of the constraint matrix A of Eq. 14 to 12×4

$$A = ( \begin{matrix}{W}_{1} - {W}_{2} \\ {W}_{1} - {W}_{3} \\ {W}_{2} - {W}_{3}\end{matrix} ) \qquad Eq . 14$$

As long as none of the wrist poses are equal, the rank of the constraint matrix A increase to three, which enables a unique solution for t to be found. Therefore, the minimum number of wrist poses to obtain a unique solution for t in the three-dimensional point constraint case is three.

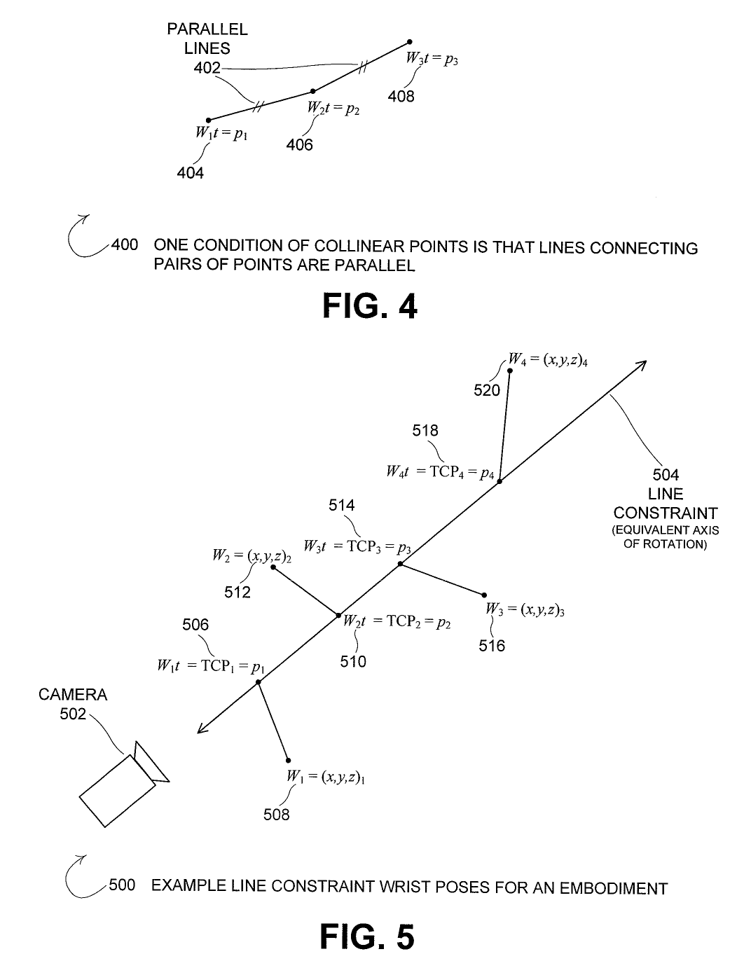

FIG. 4 is an illustration 400 of the condition for a TCP line geometric constraint that lines 402 connecting pairs of points 404, 406, 408 are parallel. In the line constraint case, the condition changes somewhat from the point constraint case. Instead of the points Wᵢt 404, 406, 408 being at the same point, the points Wᵢt 404, 406, 408 must be on the same line. There are many conditions for points 404, 406, 408 to be collinear, so the key to successfully analyzing the line constraint case is choosing an appropriate condition. Note that at least three wrist poses 404, 406, 408 must be used, because a line can always be found that passes through two points. One condition for a set of points to be collinear is that the lines connecting each pair of points are parallel. The illustration 400 in FIG. 4 shows a graphical interpretation of the condition for parallel lines. For the three points 404, 406, 408 to be collinear, the line segments 402 connecting any two points of the points 404, 406, 408 must be parallel.

FIG. 5 is an illustration 500 of example wrist poses 508, 512, 516, 520 for a TCP line geometric constraint 504 For a camera 502, a line geometric constraint 504 may be seen as a point on an image looking directly down the line constraint 504 as may be implemented by directing the camera to look down the equivalent axis of rotation 504 of wrist poses 508, 512, 516, 520 for a robot. Each wrist pose 508, 512, 516, 520 has known coordinates (x, y, z) via the kinematic model of the robot. Each wrist pose 508, 512, 516, 520 places the TCP of the tool at different TCP points (pᵢ) 506, 510, 514, 518 along the line constraint (equivalent axis of rotation) 504.

Using the set of points Wᵢt 506, 510, 514, 518, the condition that connecting lines between points Wᵢt 506, 510, 514, 518 are parallel is described by Eq. 14 below.

(Wᵢt−Wⱼt)∥(Wⱼt−Wₖt) Eq. 14

Using the dot product, the parallel condition in Eq. 14 may be expressed as in Eq. 15.

((Wᵢ−Wⱼ)t)^{T}((Wⱼ−Wₖ)t)=C Eq. 15

Where the raising to the power of T is an indication of the transposition of the matrix and C is a constant related to the magnitude of the differences between Wᵢt, Wⱼt, and Wₖt. In particular, the constant C is shown in Eq. 16.

C=∥(Wᵢ−Wⱼ)t∥∥(Wⱼ−Wₖ)t∥ Eq. 16

If the transposed term in Eq. 15 is expanded, the resulting expression is a quadratic form as shown in Eq. 17 below.

t^{T}(Wᵢ−Wⱼ)^{T}(Wⱼ−Wₖ)t−C=0 Eq. 17

Eq. 17 is a quadratic form because it is of the form shown in Eq. 18.

t^{T}Qt+b^{T}t+c=0 Eq. 18

Where Q in Eq. 18 may be defined by Eq. 19.

Q=(Wᵢ−Wⱼ)^{T}(Wⱼ−Wₖ), b=0, and c=−C Eq. 19

Each additional wrist pose introduces an additional quadratic constraint of the form shown in Eq. 17. Even though Eq. 9 shows that the number of combinations of wrist poses 508, 512, 516, 520 taken two at a time increases significantly with each additional wrist pose, most of the combinations are redundant when the parallel lines constraint is used. For example, for wrist poses W₁ 508, W₂ 512, W₃ 516, if (W₁-W₂)t is parallel to (W₂-W₃)t, then (W₁-W₂)t is also parallel to (W₁-W₃)t. Therefore, each additional wrist pose 508, 512, 516, 520 only adds one quadratic constraint.

The matrix Q in the Eqs. 18 and 19 determines the shape of the conic representing the quadratic constraint. If Q is full rank, the conic is called a proper conic. If the rank of Q is less than full, the conic is called a degenerate conic. Proper conics are shapes such as ellipses, circles, or parabolas. Degenerate conics are points or pairs of lines. To determine what sort of conic is represented for the case of the condition that lines connecting the points Wᵢt 506, 510, 514, 518 are parallel, the rank of Q must be known. Eqs. 20 and 21 are arrived at using the properties of the rank of a matrix.

rank(Wᵢ−Wⱼ)^{T}=rank(Wᵢ−Wⱼ) Eq. 20

rank((Wᵢ−Wⱼ)^{T}(Wⱼ−Wₖ))≦min(rank(Wᵢ−Wⱼ) rank(Wⱼ−Wₖ)) Eq. 21

As shown above, in two dimensions, the rank of Wᵢ−Wⱼ is no more than two, which would seem to mean that the conic represented by Q for the parallel line condition would always be degenerate, but because homogeneous coordinates are being used, the conic represented by Q for the parallel condition only results in a degenerate shape if the rank of Q is strictly less than two. In three dimensions, less may be said about the rank of Q because the homogeneous difference matrices could be of rank two or three. So the conic shape could either be a proper conic in three variables or a degenerate conic.

The properties of Q for the parallel condition may be used to determine the minimum number of wrist poses 508, 512, 516, 520 required for a unique solution for t in the line constraint 504 case. As described above, it was observed that at least three wrist poses are needed to obtain one quadratic constraint. The rank of Q is at most two, meaning that the shape of the curve is some sort of quadratic curve in two variables (e.g., a circle or an ellipse). To ensure a discrete number of solutions another wrist pose 508, 512, 516, 520 must be added to introduce a second constraint. Hence, the minimum number of wrist poses 508, 512, 516, 520 required for a solution for t in the line constraint case is four in both two and three dimensions.

It is interesting to note that for any two wrist poses 508, 512, 516, 520 in two dimensions a TCP may be found which satisfies the point constraint, meaning that for any three wrist poses 508, 512, 516, 520, a point constraint solution may be found for two of the wrist poses 508, 512, 516, 520, causing two of the world coordinate points to be the same. This reduction in the number of available points from three to two causes the solution for the line constraint problem to be trivial, also indicating that a fourth wrist pose 508, 512, 516, 520 is needed.

As described above, the location of the TCP relative to the wrist-frame (i.e., the translation of TCP to the wrist-frame) may be performed with a minimum of three wrist poses 508, 512, 516, 520 for a 3-D point constraint or four wrist poses 508, 512, 516, 520 for a 3-D line constraint. Although the TCP relative to the wrist-frame may be calculated with the minimum number of required wrist poses 508, 512, 516, 520, it may be beneficial to use more wrist poses 508, 512, 516, 520. For some embodiments, the number of wrist poses 508, 512, 516, 520 may exceed the minimum number of wrist poses 508, 512, 516, 520 by only a few wrist poses 508, 512, 516, 520 and still provide reasonable results. The more wrist poses 508, 512, 516, 520 obtained, the more room for error there is in enforcing the specific geometric constraint (e.g., point/line constraints). Thus, an embodiment may use a large number of wrist poses 508, 512, 516, 520 to alleviate the need for an embodiment to make minute corrections to individual wrist poses 508, 512, 516, 520. Thus, an embodiment may be preprogrammed to automatically perform the large number (30-40) of wrist poses 508, 512, 516, 520 with only corrective measurements from the camera needed to obtain a sufficiently accurate TCP translational relationship to the robot wrist. Automatically performing a large number (30-40 of wrist poses 508, 512, 516, 520 permits an embodiment to avoid a need for an operator to manually ensure that the TCP is properly constrained within the image captured by the camera. An automatic embodiment may also evenly space the wrist poses 508, 512, 516, 520 rather than using random wrist poses 508, 512, 516, 520. Using many evenly spaced wrist poses 508, 512, 516, 520 permits an embodiment to relatively easily generate the desired wrist poses 508, 512, 516, 520 as well as permitting greater control over the robot movement as whole. As may be self-evident, the wrist position and orientation for each wrist pose 508, 512, 516, 520 may be recorded in/on a computer readable medium for later use by the TCP location computation algorithms.

While the point constraint formulation in Eq. 8 may be used to solve for t by computing the SVD of the constraint matrix and then scaling the null vector, the current line constraint formulation in Eq. 17 cannot be used to solve for t because C is unknown. Therefore an iterative method was implemented to solve for t in the line constraint case. The iterative algorithm is based on the method of Nelder and Mead. For more information on the method of Nelder and Mead see W. H. Press, B. P. Flannery, and S. A. Teukolsky “Downhill simplex method in multidimensions,” Section 10.4 in Numerical Recipes in C: The Art of Scientific Computing, Cambridge University Press, pp 408-412, 1992. The Nelder and Mead method requires an initial approximation (i.e., guess) for t, and computes a least-squares line fit using the SVD (see Appendix B section below). The sum of the residuals from the least-squares fit is used as the objective function, and approaches zero as t approaches the true TCP. A version of the main TCP calibration method described above may be used to generate the initial approximation for t if no approximation exists. The main difference between the method to obtain an initial approximation for t and the method to obtain the TCP location relative to the wrist-frame is that the method to obtain an initial approximation for t moves wrist poses 508, 512, 516, 520 about the center of the robot wrist rather than the TCP of the tool because the TCP of the tool is unknown.

It is important to note that the TCP calculation algorithm described above requires that wrist pose 508, 512, 516, 520 information be gathered and a corresponding TCP translation relationship to the robot wrist-frame be performed only once to arrive at a final TCP relationship to the robot wrist-frame. That is, it is not necessary to iteratively repeat a process of performing a number of wrist poses 508, 512, 516, 520, correcting the TCP location (i.e., correcting the TCP relationship to the robot wrist-frame) over and over until the TCP location is “close enough.” An embodiment performs the desired number of wrist poses 508, 512, 516, 520 while maintaining the specified geometric constraint (e.g., point/line constraint) for the TCP location in the camera image and then calculates the TCP location relative to the robot wrist-frame using the computational algorithms described above. Also, only a single point on the tool need be identified in the image to implement the TCP calculation algorithm. Thus, it is not necessary to locate multiple useful features in the image of the tool, only a single point.

Tool-Frame Cal. Stage 2 (Optional): Calibrating the Tool Orientation

For some tools and processes, finding only the TCP relationship to the wrist frame is adequate. For example, if a touch probe extends directly along the joint axis of the last joint (i.e., the wrist), the orientation of the tool may be assumed to be equal to the orientation of the wrist. However, for many tools additional information is needed about the orientation of the tool. Welding processes, for example, have strict tolerances on the angle of the torch. For example, errors in the torch angle may cause undercut, a condition where the arc cuts too far into the metal. For the robot to have the ability to position the torch within the process tolerances, it is desirable for the orientation component of the tool-frame to be accurately calibrated.

One method of finding the tool orientation is to move the tool into a known orientation in the world coordinate frame. The wrist pose may then be recorded and the relative orientation between the tool and the wrist may be computed. However, the method of moving the tool into a known orientation in the world coordinate frame often requires a jig or other special fixture and is also typically very time consuming.

Another option is to apply the method described above for computing the tool center point a second time using a point on the tool other than the TCP. For example, the orientation of a tool may be found by performing the TCP calibration procedure using another point along the tool direction. A new point in the wrist-frame would then be computed, and the tool direction would then be the vector between this new point and the previously found TCP. Calibrating using the method described above for the TCP calibration, but for a different point on the tool has the advantage of using previously developed techniques, which also do not require specialized equipment.

Tool-Frame Cal. Stage 3 (Optional): Calibrating Tool Operation Direction

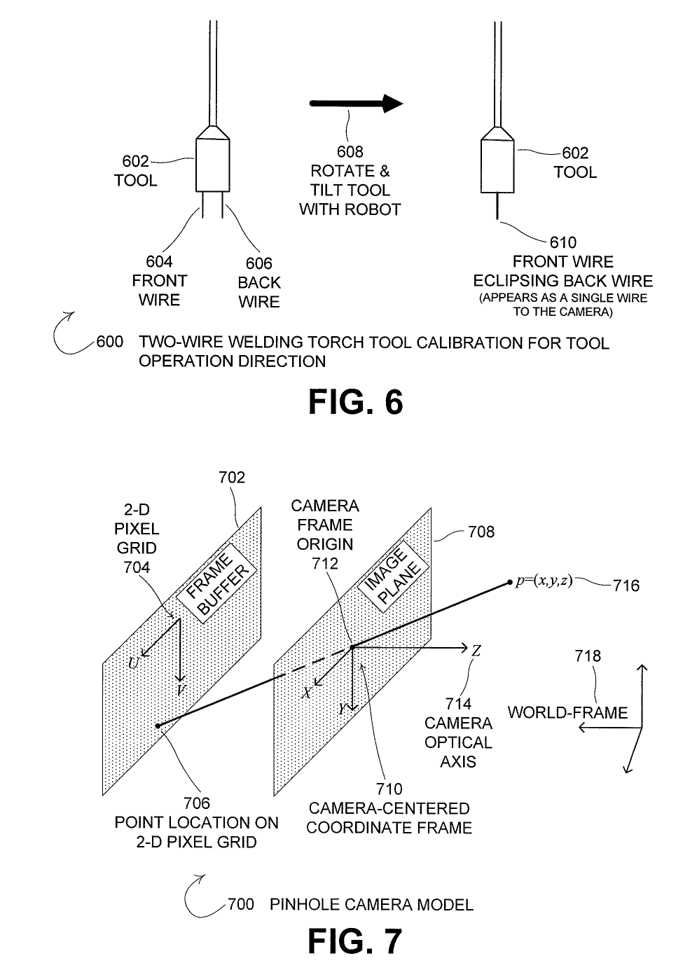

FIG. 6 is an illustration 600 of a calibration for tool operation direction for a two-wire welding torch. For some tools, a third calibration stage may be added to address properly situating the tool 602 for an operation direction. For example, a two-wire welding torch tool should be aligned such that the two wires 604, 606 of the tool 602 are aligned together along a weld seam in addition to locating the center point and the relative orientation of the tool relative to the wrist-frame. To help to understand the tool-frame calibration process, the calibration of the tool center point (first stage) may be thought of as calibration of the tool-frame origin, calibration of the tool orientation (second stage) may be thought of as calibration for one axis of the tool-frame (e.g., the z-axis), and calibration of the tool operation direction may be thought of as calibration of a second axis of the tool-frame (e.g., the y-axis). If desired, a fourth stage may be added to calibrate along the third axis (e.g., the x-axis), but the third axis may also be found as being orthogonal to both of the other two axes already calibrated.

To calibrate a tool operation direction for a two-wire welding torch tool 602, an embodiment rotates and tilts the tool with the robot 608 until the front wire 604 and the back wire 606 appear as a single wire 610 in the image captured by the camera. It is not important which wire is the front wire 602 or the back wire 606, just that one wire 604 eclipses the other wire 606 making the two wires 604, 606 appear as a single wire 610 in the image captured by the camera. The position and orientation of the robot and robot wrist are recorded when the two wires 604, 606 appear as a single wire 610 in the camera image and the recorded position and orientation are built into the kinematic model of the robotic system to define an axis of the tool-frame.

Vision Concepts

Before vision may be applied to calibration of the unknown tool-frame relative to the known wrist-frame, it is desirable to understand some concepts about camera models and calibration techniques. This section on Vision Concepts presents a brief overview of the pinhole camera model, followed by a description of some techniques for calibrating a camera.

Pinhole Camera Model

FIG. 7 is an illustration 700 of the pinhole camera model for camera calibration. The camera model used in the description of the various embodiments is the standard pinhole camera model, illustrated 700 in FIG. 7. A camera-centered coordinate frame 710 is typically defined with the origin 712 at the optical center 712 and the z-axis 714 corresponding to the optical axis 714. A projective model typically defines how points (e.g., point 716) in the camera-centered coordinate frame 710 appear on the image plane 708, and scaling factors typically define how the image plane 708 is mapped into the pixel-based frame buffer 702. Thus, a point 716 in the world-frame 718 would project through the image plane 708 with the camera-centered coordinate frame 710 and appear at a point location 706 on the two-dimensional pixel-based frame buffer 702. The pixel-based frame buffer 702 may be defined with a two-dimensional grid 704 of pixels that has two axes typically indicated by a U and a V (as shown in illustration 700).

To use a camera to measure objects in the real world, it is desirable to know the parameters of the camera relative to the real world. Camera calibration involves accurately finding the camera parameters, which include the parameters of the pinhole projection model (e.g., the camera-centered coordinate frame 710 of the image plane 708 and the relationship to the two-dimensional grid 704 of the frame buffer 702) as well as the position and orientation of the camera in some world-frame 718. Many methods exist for calibrating the camera parameters, but probably the most widespread and flexible calibration method is the self-calibration technique, which provides a way to calibrate the camera without the need for expensive and specialized equipment. For further information on the self-calibration technique see Z. Zhang, “A flexible new technique for camera calibration,” IEEE Transactions on Pattern Analysis and Machine Intelligence, Vol. 22, No. 11, pp. 1330-1334, November 2000; R. Tsai, “A versatile camera calibration technique for high-accuracy 3D machine vision metrology using off-the-shelf TV cameras and lenses,” IEEE Journal of Robotics and Automation, Vol. 3, No. 4, pp. 323-344, August 1987; and/or R. K. Lenz and R. Y. Tsai, “Techniques for calibration of the scale factor and image center for high accuracy 3-D machine vision metrology,” IEEE Transactions on Pattern Analysis and Machine Intelligence, Vol. 10, No. 5, pp. 713-720, September 1988.

The effect of lens distortion is often included in the projection model to increase accuracy. Lens distortion may include radial and tangential components, and different models may include different levels of complexity. Most calibration techniques, including self-calibration, can identify the parameters of the lens distortion model and correct the image to account for them.

Two-Dimensional Camera Calibration

If the measurements of interest are only in two dimensions, then the camera calibration procedure becomes relatively simple. If perspective errors and lens distortion are ignored, the only calibration that is typically necessary is a scaling factor between the pixels of the image in the frame buffer 702 and whatever units are being used in the real world (i.e., the world-frame 718). This scaling factor is based on the intrinsic camera parameters and on the distance from the camera to the object (e.g., point 716). If perspective effects and lens distortion are included, the model becomes slightly more burdensome but still avoids most of the complexity of full three-dimensional calibration. Two-dimensional camera calibrations are often used in systems with a camera mounted at a fixed distance away from a conveyor.

Three-Dimensional Camera Calibration

Full three-dimensional (3-D) calibration typically includes finding both the parameters of the pinhole camera model (intrinsic parameters) and the location of the camera in the world-frame 718 (extrinsic parameters). Intrinsic camera calibration typically includes finding the parameters of the pinhole model and of the lens distortion model. Extrinsic camera calibration typically includes finding the six parameters that represent the rotation and translation between the camera-centered coordinate frame 710 and the world-frame 718. These two steps may often be performed simultaneously, but performing the steps simultaneously is not always necessary.

In the full camera calibration, the relationship between three-dimensional points X, Y,Z,1)^{T} in the world-frame and two-dimensional points (u, v, 1)^{T} in the image may be expressed by Eq. 22 below.

$$s ( \begin{matrix}u \\ v \\ 1\end{matrix} ) = A ( R t ) ( \begin{matrix}X \\ Y \\ Z \\ 1\end{matrix} ) \qquad Eq . 22$$

Where R and t are the extrinsic parameters that characterize the rotation and translation from the robot world-frame 718 to the camera-centered frame 710. The parameter s is an arbitrary scaling factor. A is the camera intrinsic matrix, described by Eq. 23 below.

$$A = ( \begin{matrix}α & 0 & {u}_{0} \\ 0 & β & {v}_{0} \\ 0 & 0 & 1\end{matrix} ) \qquad Eq . 23$$

Where α and β are the scale factors in the image u and v axes of the two-dimensional (2-D) pixel grid 704 of the frame buffer 702, and u₀ and v₀ are the coordinates of the image center. In the described camera model, there are six extrinsic and four intrinsic parameters.

FIGS. 8A-C show example images 800, 802, 804 of a checkerboard camera calibration device used to obtain a full 3-D calibration of a camera. FIG. 8A is an example camera calibration image for a first orientation 802 of a checkerboard camera calibration device. FIG. 8B is an example camera calibration image for a second orientation 802 of a checkerboard camera calibration device. FIG. 8C is an example camera calibration image for a third orientation 806 of a checkerboard camera calibration device. Estimation of the six extrinsic and four intrinsic parameters of the described camera model is usually accomplished using 3-D to 2-D planar point correspondences between the image and some external frame of reference, often defined on a calibration device. In the self-calibration procedure, the external reference frame is a local coordinate frame on a checkerboard pattern printed on a piece of paper, with known corner spacing. Several images are then taken of the calibration pattern, and the image coordinates of the corners are extracted. If the position and orientation of the calibration pattern are known in the world-frame 718, then the full intrinsic and extrinsic calibration is possible. If the pose of the checkerboard in the world-frame 718 is unknown, then at least intrinsic calibration may still be performed.

Partial Three-Dimensional Camera Calibration

In the interest of avoiding the use of special calibration tools (see FIGS. 8A-C), it would be desirable to use the tool attached to the robot itself to calibrate the camera. Using the tool attached to the robot to calibrate the camera may be accomplished by moving the tool to a number of planar positions in the robot world coordinate system 718 and measuring the image coordinates of the tool center point for each of these positions. However, if the tool-frame of the robot is not calibrated, it is impossible to determine the correct 3-D to 2-D point correspondences for the above described full 3-D camera calibration procedure because the robot controller only has information about the position of the wrist and no information about the position of the tool. However, it is possible to use a simplified extrinsic calibration procedure to compute the rotation between the camera-centered coordinate frame 710 and the world-frame 718.

Because the tool itself is being used to generate the planar point correspondences, it is impossible to determine t in Eq. 22 if the TCP is unknown. Therefore, the translation portion of the extrinsic relationship is unknown and only the rotational parameters may be computed. However, for the partial 3-D camera calibration to work it is desired that the robot still be constrained to move in a plane.

It is clear that a translation of the robot wrist results in the same translation for the tool center point, regardless of the tool geometry. Thus, the wrist of the robot may be translated in a known plane and the corresponding tool center points in the image may be recorded using an image processing algorithm. The translation of the robot wrist and recording of tool center points in the image results in a corresponding set of planar 3-D points, which are obtained from the robot controller, and 2-D image points, which may then be used to compute the rotation from the camera-centered coordinate system 710 to the robot world coordinate system 718 using standard numerical methods. It is important to note that the 3-D planar points and the 2-D image points do not necessarily correspond in the real world, but in fact may differ by the uncalibrated translational portion of the tool-frame. However, this translational difference does not affect the rotation.

Another way to view the partial 3-D camera calibration is that a plane in world coordinates 718 is computed that corresponds to the image plane 708 of the camera. While the translation between the image plane 708 and the world-frame 718 cannot be found because the TCP is unknown, a scaling factor can be incorporated in a similar fashion to the 2-D camera calibration so that image information may be converted to real-world information that the robot can use. Including the scaling factor yields Eq. 24, which is a simplified relationship between image coordinates 710 and robot world coordinates 718.

$$( \begin{matrix}X \\ Y \\ Z \\ 1\end{matrix} ) = ( R ) ( \begin{matrix}α & 0 & 0 \\ 0 & β & 0 \\ 0 & 0 & 1\end{matrix} ) ( \begin{matrix}u \\ v \\ 1\end{matrix} ) \qquad Eq . 24$$

Where α and β are the scaling factors from pixels in the frame buffer 702 to robot world units in the u and v directions of the frame buffer 708, respectively. R is a rotation matrix representing the rotation from the camera-centered coordinate frame 710 to the robot world coordinate frame 718. The parameters for the image center 712 are omitted in the intrinsic matrix because this type of partial calibration is only useful for converting vectors in image space to robot world space. Because the full translation is unknown, no useful information is gained by transforming only a single point from the image into robot space. The vectors of interest in the image are independent of the origin 712 of the image frame 710, so the image center 712 is not important and need not be calibrated for the vision-based tool center point calibration application.

In Eq. 24, the rotation matrix is calibrated using the planar point correspondences described above. The scale factors are usually found by translating the wrist of the robot a known distance and measuring the resulting motion in the image. The desired directions for the translations of the wrist of the robot are the u and v directions of the frame buffer 702 of image plane 708, which may be found in robot world coordinates 718 through the previously computed rotation matrix of the partial 3-D camera calibration. This simplified extrinsic relationship allows vectors in the image frame 710 to be converted to corresponding vectors in robot world coordinates 718.

Note that in the partial 3-D camera calibration process, there are only three extrinsic and two intrinsic parameters that must be calibrated, which is a significant reduction from the full 3-D camera calibration. Also note that the vectors in robot world coordinates 718 will all lie in a plane. Because of this, the partial 3-D camera calibration is only valid for world points 718 in a plane. As soon as the robot moves out of the plane, the scaling factors will change slightly. However, it turns out that the partial 3-D camera calibration gives enough information about the extrinsic camera location to perform several interesting tasks, including calibrating the TCP.

Using Vision to Calibrate a Tool

With the framework for calibrating a tool with a simple geometric constraint described above, the use of a vision system to actually perform this calibration may be described. The camera may be used to continuously capture an image of the target tool in real-time. Embodiments may store an image and/or images at desired times to perform calculations based on the stored image and/or images.

Extraction of TCP Data

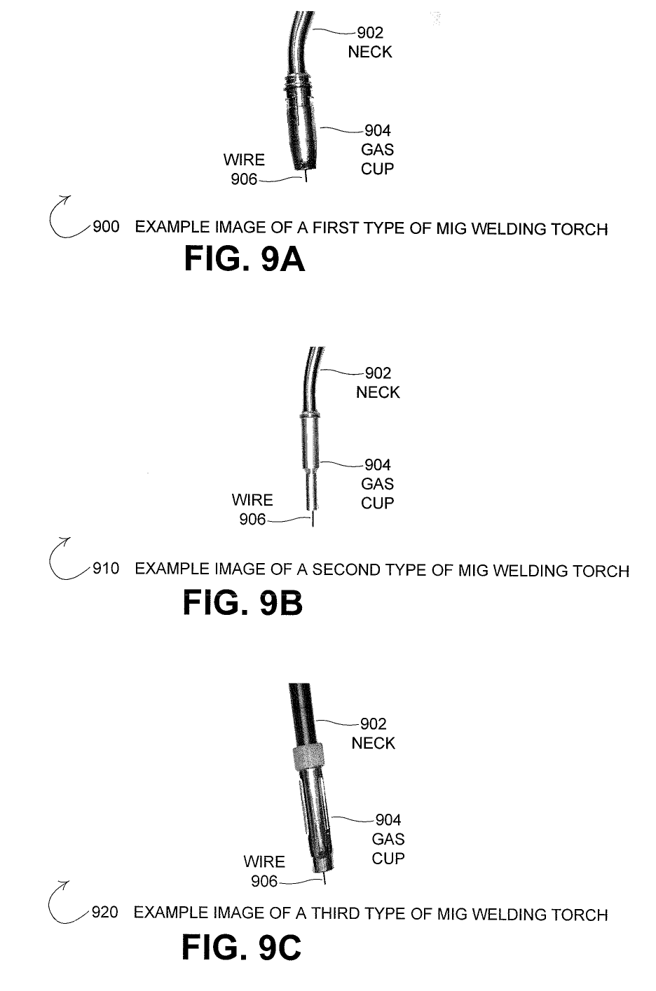

FIGS. 9A-C show images 900, 910, 920 of example Metal-Inert Gas (MIG) welding torches. FIG. 9A is an example image of a first type 900 of a MIG welding torch tool. FIG. 9B is an example image of a second type 910 of a MIG welding torch tool. FIG. 9C is an example image of a third type 920 of a MIG welding torch tool. Depending on the type of tool that is being used, slightly different methods must be employed to find the TCP and tool orientation in the camera image. A good example of a common industrial tool is the MIG welding torch (e.g., 900, 910, 920). FIGS. 9A-C show several examples of a MIG welding torch tool. While welding torches have the same basic parts (e.g., neck 902, gas cup 904, and wire 906), the actual shape and material of the parts 902, 904, 906 may vary significantly, which can make image processing difficult.

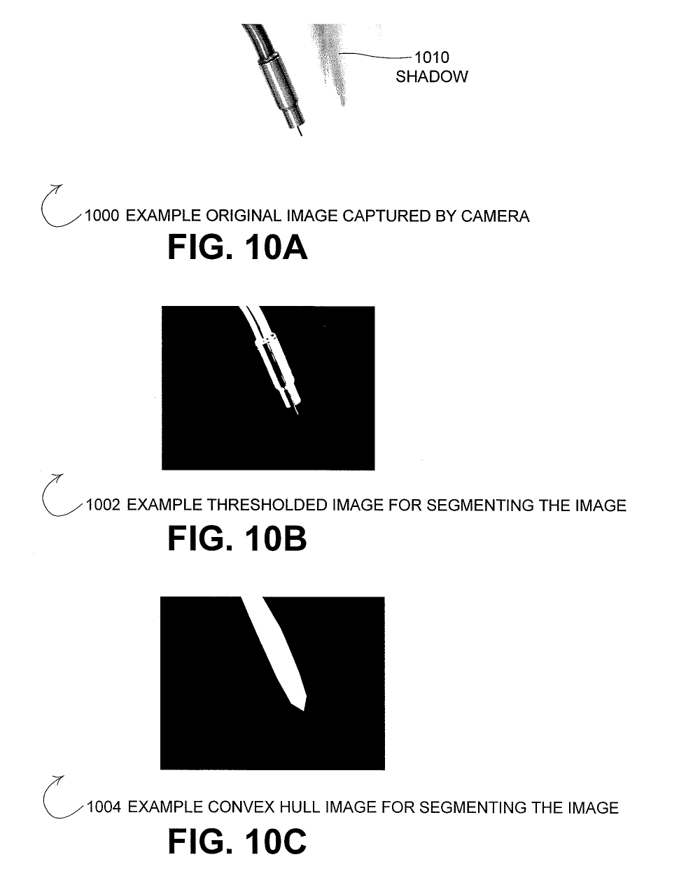

A process for extracting the two-dimensional tool center point and orientation from the camera image may be as follows and as shown in FIGS. 10A-C and 11A-C:
1. Segment the original image 1000 by thresholding 1002 and computing the convex hull 1004.
2. Find the rough orientation 1114 of the tool 1102 in the original image 1000 by fitting an ellipse 1104 to the segmented data result of the convex hull 1004.
3. Refine the orientation 1116 of the tool 1102 by searching for the sides 1112 of the tool 1102.
4. Search 1122 for the TCP (1124 or 1126) at the end of the tool 1102.

FIGS. 10A-C show example images of the process of segmenting the original image 1000 into a convex hull image 1004 for step 1 of the process described above using a MIG welding torch as the tool. FIG. 10A is an example image of an original image 1000 captured in a process for locating a TCP of a tool on the camera image. FIG. 10B is an example image of the thresholded image 1002 created as part of the sub-process of segmenting the original image 1000 in the process for locating the TCP of the tool on the camera image. FIG. 10C is an example image of the convex hull image 1004 created as part of the sub-process of segmenting the original image 1000 in the process for locating the TCP of the tool on the camera image. For step 1 of the process for finding the TCP of the tool in the camera image 1000, the camera image 1000 is first thresholded 1002 to separate the torch from the background, and then the convex hull 1004 is found in order to fill in the holes in the center of the torch. Note that the shadow 1010 of the tool in the upper right of the original image 1000 is effectively filtered out in the thresholding 1002 step.

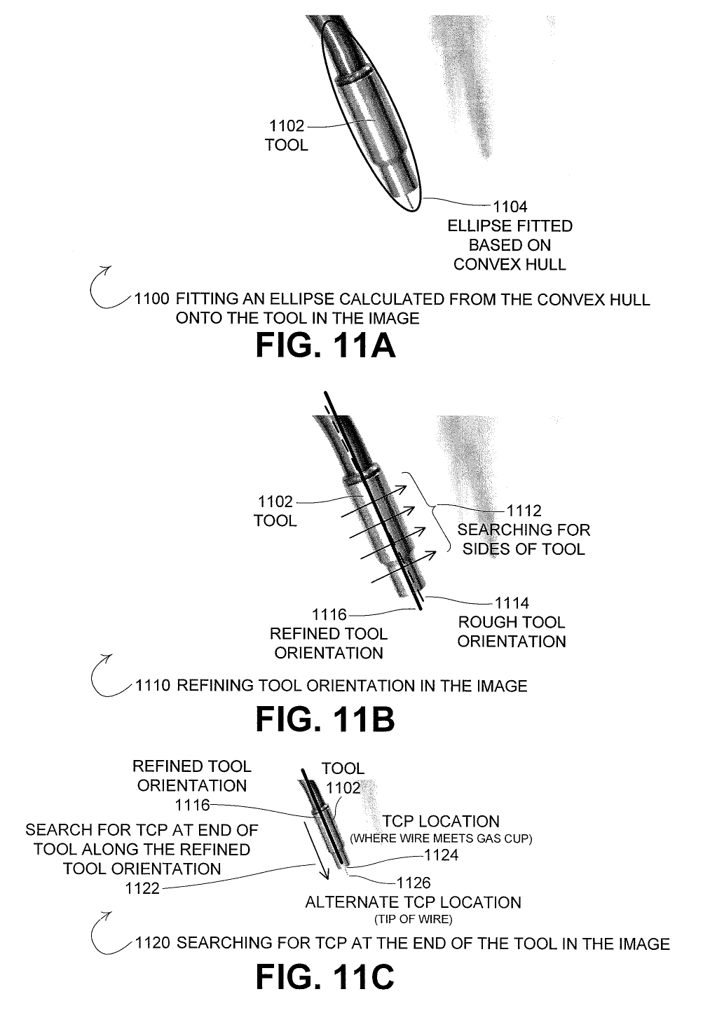

FIGS. 11A-C show example images of the remaining sub-process steps 2-4 for finding the TCP (1124 or 1126) of the tool 1102 in the original camera image 1000. FIG. 11A is an example image 1100 showing the sub-process for step 2 of finding a rough orientation 1114 of the tool 1102 by fitting an ellipse 1104 around the convex hull image 1004 in the process for locating the TCP (1124 or 1126) of the tool 1102 on the camera image 1000. FIG. 11B is an example image 1110 showing the sub-process for step 3 of refining the orientation 1116 of the tool 1102 by searching for the sides 1112 of the tool 1102 in the process for locating the TCP (1124 or 1126) of the tool 1102 on the camera image 1000. Step 3 to find a refined orientation 1116 of the tool 1102 of the process for finding the TCP (1124 or 1126) in the camera image 1000 is necessary because the neck of the torch tool 1102 may cause the fitted ellipse 1104 to have a slightly different orientation (i.e., rough orientation 1114) than the nozzle of the tool 1102. Usually the TCP of the tool 1102 is defined to be where the wire exits the nozzle 1124, so in step 4 of the process for finding the TCP in the camera image 1000, the algorithm is really searching for the end of the gas cup of the tool 1124. For some embodiments, the TCP may alternatively be defined to be the actual end of the torch tool 1102 at the tip of the wire 1126. Other types of tools may have different TCP locations as desired or needed for the tool type. Thus, the location of the specific TCP for different tool types may require a modified tool 2-D TCP extraction process to account for the differences in the tool. Step 4 of searching for the TCP in the image will likely require the most modification between different tool types, but steps 1-3 may also require modification to account for geometric variances between different types of tools. FIG. 11C is an example image 1120 showing the sub-process for step 4 of searching 1122 for the TCP (1124 or 1126) at the end of tool 1102 in the overall process for locating the TCP (1124 or 1126) of the tool 1102 on the camera image 1000. The search 1122 to the end of the tool 1102 for the TCP (1124 or 1126) may be performed by searching along the refined tool orientation 1116 for the TCP (1124 or 1126).

Enforcing Point and Line Constraints

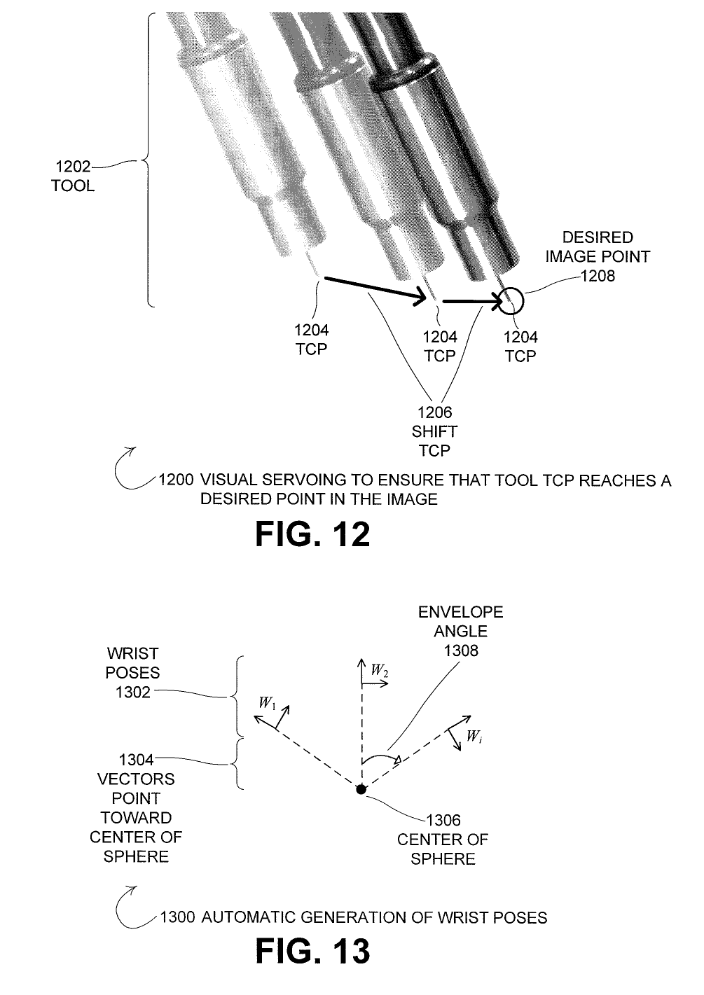

FIG. 12 is an illustration of visual servoing 1200 used to ensure that the tool 1202 TCP 1204 reaches a desired point 1208 in the camera image. It is relatively simple to see how to enforce a geometric constraint on the TCP 1204 if the basic projective nature of a vision system is considered. A line in the image corresponds to a plane in 3-D space, while a point in the image corresponds to a ray (i.e., line) in 3-D space, originating at the optical center and passing through the point on the image plane. Therefore, if the TCP 1204 is to be constrained to lie on a plane, the TCP 1204 lies on a line in the image. Likewise, if the line constraint is to be used in 3-D space, the TCP 1204 is at a point in the image. If the point constraint is to be used in 3-D space, the situation becomes more complicated. One way of achieving the 3-D point constraint is to constrain the TCP 1204 to be at a desired point 1208 in the image, and then rotate the wrist poses by 90 degrees about their centroid. The TCP's 1204 are then moved again to be at a desired point 1208 in the image, which will guarantee that they are in fact at a point in 3-D space. This method, however, is complicated and could be inaccurate. Therefore, the line constraint is preferred for implementing the various embodiments.

It is important to note that if the partial 3-D calibration method is used for calibrating the camera, the extrinsic parameters of the camera calibration are only valid for a single plane in the robot world coordinates. In practice, however, the TCP 1204 of the robot's tool 1202 will move out of the designated plane. Therefore, care should be taken when using image vectors to generate 3-D motion commands for the robot, because the motion of the robot will not always exactly correspond to the desired motion of the TCP 1204 in the image. To overcome the non-correspondence between the motion of the TCP 1204 and the motion of the robot, a kind of visual servoing technique may be used. In the visual servoing technique, the TCP 1204 of the tool 1202 is successively moved closer 1206 to the desired point 1208 in the image until the TCP 1204 is within a specified tolerance of the desired point 1208. The shifts 1206 in the TCP 1204 location in the image should be small so that the TCP 1204 location in the image is progressively moved closer to the desired image point 1208 without significantly going past the desired point 1208. Various schemes may be used to adjust the shift 1206 direction and sizes that would achieve the goal of moving the TCP 1204 in the image to the desired image point 1208. A more proper statement of how the shifts 1206 are implemented may be a shift in the robot wrist pose that causes a corresponding shift 1206 in the TCP 1204 location in the image.

Various embodiments may choose to increase the number of wrist poses to 30-40 wrist poses and collect correction measurements of the location of the TCP 1204 in the image with regard to the desired image point 1208 and then apply the correction measurements from the camera to the wrist pose position and orientation data that generated the TCP 1204 locations. While the correction measurements from the camera may not be as accurate as moving the wrist pose until the TCP 1204 is at the desired point 1208 on the image, the large number of wrist poses provides sufficient data to overcome the small accuracy problems introduced by not moving the TCP 1204 to the desired image point 1208.

Using Vision to Compute Tool Orientation

One way of computing the tool orientation using a vision system is to measure the angle between the tool 1202 and the vertical direction in the image. Using the partial 3-D camera calibration, the robot may be commanded to correct the tool orientation by a certain amount in the image plane. The tool 1202 may then be rotated 90 degrees about the vertical axis of the world-frame and the correction may be repeated. This ensures that the tool direction is vertical, which allows computation of the tool orientation relative to the wrist-frame. However, this method is iterative and time-consuming. A better method would use the techniques already developed for finding the TCP 1204 relative to the robot wrist-frame with a second point on the tool 1202.

The information gained from the image processing algorithm includes the TCP 1204 relative to the wrist-frame and the tool direction in the image. The TCP 1204 relative to the wrist-frame and the tool direction in the image may be used to find a second point on the tool that is along the tool direction. If the constraints from the Calibrating the Tool-Frame section of this disclosure are applied to the new/second point, the TCP calibrating method described in the Calibrating the Tool-Frame section may be used to find the location of the new/second point relative to the wrist-frame. The tool orientation may then be found by computing the vector between this new/second point and the previously calculated TCP relative to the wrist-frame.

To implement an embodiment an external camera may be used to capture the image of the tool. Some embodiments may have a separate camera and a separate computer to capture the image and to process the image/algorithm, respectively. The computer may have computer accessible memory (e.g., hard drive, flash drive, RAM, etc.) to store information and or programs needed to implement the algorithms/processes to find the tool-frame relative to the wrist-frame of the robot. The computer may send commands to and receive data from the robot and robot controller as necessary to find the relative tool-frame. While the computer and camera may be separate devices, some embodiments may use a “smart camera” that combines the functions of the camera and computer into a single device. The computer may be implemented as a traditional computer or as a less programmable firmware (i.e., FPGA, ASIC, etc.) device.

In order to provide a better and/or clearer image from the camera, additional filters may be added to deal with reflections and abnormalities seen in the image (e.g., scratches in the lens cover, weld splatter, etc.). One example filter that may be implemented is to reject portions of the image that are close to the edges of the image.

Results

In order to gain some insight into the tool calibration method and verify the analysis from the Tool-Frame Cal. Stage 1: Calibrating the Tool Center Point (TCP) section above, simulations in two and three dimensions were performed. Data was also collected using a real robotic system.

Two-Dimensional Simulation Results

In the two-dimensional case, it is useful to visualize the possible solutions by varying the TCP over a particular range and performing a least-squares fit for the particular constraint (see Appendix B section below). If the TCP is a solution, the sum of the residuals in the least-squares fit will be zero. The error for the solution may be written as in Eq. 25.

$$ɛ = {\sum }_{i = 1}^{N} {‖ {p}_{i} - {c}_{i} ‖}^{2} \qquad Eq . 25$$

Where cᵢ is the point on the constraint geometry that is closest to pᵢ. In the point case, cᵢ is the centroid, and in the line case cᵢ is the point on the line closest to pᵢ.

For example, in the point constraint case, the TCP was varied over a two-dimensional range, and the set of points pᵢ in the world-frame were computed for each possible TCP. The least-squares fit was then computed, and the residuals were computed as the magnitude of the difference between the point pᵢ and the centroid of the points p₀. When t is close to the true TCP, the sum of the residuals is very small. The wrist poses were manually positioned by the user in these simulations, introducing some error into the wrist pose data. In the simulations the true TCP was set to be (50,50,1)^{T}.

For a simulation of a point constraint with two wrist poses, the result agrees with the result from the analysis in the Tool-Frame Cal. Stage 1: Calibrating the Tool Center Point (TCP) section above, which concluded that two wrist poses is sufficient for a unique solution for t. To analyze the simulation, the solution is the value of t for which ε is small, which corresponds to a single minimum in a plot of the results. To solve for the TCP, first the constraint matrix is formed. From Eq. 8 A (the constraint matrix) is computed to be:

$$A = ( \begin{matrix}1.2 & 0.979 & - 108 \\ - 0.979 & 1.2 & - 11.8 \\ 0 & 0 & 0\end{matrix} )$$

Note that the last row in A is zero, indicating that the matrix is singular. The singular value decomposition is:

$$U = ( \begin{matrix}- 0.99 & 0.108 & 0 \\ - 0.108 & - 0.99 & 0 \\ 0 & 0 & 1\end{matrix} ) , \\ Σ = ( \begin{matrix}108.9 & 0 & 0 \\ 0 & 1.55 & 0 \\ 0 & 0 & 0\end{matrix} ) , and$$

$$V = ( \begin{matrix}- 0.01 & 0.712 & 0.702 \\ - 0.01 & - 0.702 & 0.712 \\ 0.999 & 0 & 0.014\end{matrix} )$$

Therefore, the null space of A is spanned by the third singular vector of V, (0.702,0.712,0.014)^{T}, which corresponds to the zero singular value. Because homogeneous coordinates are used, the correct TCP will be a scaled version of vector V so that the last element is one. For 2-D two wrist pose example, scaling the vector V appropriately yields (50.14,50.86,1)^{T}. The actual TCP was (50,50,1)^{T}, so the algorithm returned a substantively correct solution. The difference between the two vectors calculated and actual vectors may be due to both round off errors and errors in the wrist pose data.

In the line constraint case, a similar procedure may be followed to verify the analysis in the Tool-Frame Cal. Stage 1: Calibrating the Tool Center Point (TCP) section above. For a line constraint with three wrist poses, the analysis the Tool-Frame Cal Stage 1: Calibrating the Tool Center Point (TCP) section above indicated that the solutions for the line constraint case with three wrist poses satisfied a single quadratic constraint in two dimensions. A plot in of the solutions clearly showed that the solutions lied on a circle resulting from the quadratic constraint. Thus an incorrect solution that still satisfies the quadratic constraint may be found.

After adding a fourth wrist pose the solutions plot looked similar to the three wrist pose line constrain case, but does indeed have only a single solution. In the plot, the minimum is not very clearly defined and has the potential to cause numerical problems that could affect the solution. However, the definition problems may be caused by the fact that the wrist poses were all fairly similar in orientation, differing by at most 90 degrees. A solution to the conditioning problem is to change the relative orientations of the wrist poses. A plot of a simulation that radically changes the orientation of one of the wrist poses has a minimum that is much more clearly defined. Therefore, the problem is better conditioned indicating that the difference between the wrist poses is important, and that a wide variety of wrist poses may help the conditioning of the problem.

It may also be useful to examine the effect of errors or noise in the wrist pose data on the final solution for the TCP. In practice, the wrist poses will have errors resulting from several sources, including vision and kinematic errors. To simulate this effect, Gaussian noise of zero mean and variable magnitude was added to the wrist pose data before the TCP was computed. A plot of the error in the TCP computation as the noise level increases suggested two practical tips for using the TCP calibration algorithm. First, using more wrist poses than necessary helps to decrease the effect of errors in the wrist pose data. Second, it is important for the numerical conditioning of the problem to have the wrist poses be as different as possible. However, in practice using the tips may not always be achievable because the robot's work cell may have other obstacles to the robot's potential motion. Also, if vision is used, the TCP must remain in the field of view of the camera.

Three-Dimensional Simulation Results

Visualizing the solutions to the problem in three dimensions is harder, but may be accomplished through the use of volume rendering and contour surfaces. In a volume plot, the contour levels of the function are seen as surfaces, while the actual function value is represented by a color. The data for a three-dimensional simulation was generated for using a similar program as for the two-dimensional case, in which the user manually positioned a number of wrist-frames on the computer screen. The TCP was then varied over a specified range, and the sum of the residuals was computed in a least-squares fit of the constraint to the points pᵢ. The error, ε, was then visualized as a volume rendering.

As with the two-dimensional case, the point constraint was considered first. As described in the Tool-Frame Cal. Stage 1: Calibrating the Tool Center Point (TCP) section above, for a three-dimensional embodiment, the point constraint was deemed to require three wrist poses to obtain a TCP relationship to the robot's wrist-frame. The color of the volume rendering plot for the three-dimensional point constraint simulation with only two wrist poses showed the magnitude of the objective function (i.e., error in least-squares fit). The contour surfaces of the function gave some idea of where the solutions were. Because the contour surfaces in the plot were becoming smaller and smaller cylinders, the solutions lied on a line. Having a line of solutions agrees with the three-dimensional point constraint analysis in the Tool-Frame Cal. Stage 1: Calibrating the Tool Center Point (TCP) section above because there was an incorrect solution that still satisfies the constraint equations confirming that more than two wrist poses are needed for a three-dimensional point constraint. When three wrist poses were used for the three-dimensional point constraint, the volume plot illustrated that with the additional wrist pose the contour surfaces converged to a point, meaning that there is a single solution. Thus, it was confirmed that at least three wrist poses are needed to find the TCP when a three-dimensional point constraint is used. Similar to the two-dimensional case, more than three poses may be used to reduce the effect of errors in the wrist pose data.

The line constraint in three dimensions was examined next. A simulation with only three wrist poses was performed with the 3-D line constraint. The contour surfaces of the plot of the simulation of the 3-D line constraint with three wrist poses showed that the solutions lied on a curve in space. From the analysis in the Tool-Frame Cal. Stage 1: Calibrating the Tool Center Point (TCP) section it is apparent that the solution curve in space shows the solution curve is a quadratic sort of curve, which may be proper or degenerate. Thus, the results showed that an incorrect solution may result from using only three wrist poses, illustrating the need for an additional wrist pose.

When four wrist poses were used for the simulation of the 3-D line constraint the contour surfaces of the plot showed a closed shape indicating that there is only one solution for the 3-D line constraint with four wrist poses. Thus, it is clear that no fewer than four wrist poses are required to compute the TCP if the three-dimensional line constraint is used, which confirms the analytical result in the Tool-Frame Cal. Stage 1: Calibrating the Tool Center Point (TCP) section.

Real System Testing Results

After the three-dimensional simulation and analysis, a preferred method was chosen for implementation on a real system. In particular, the three-dimensional line constraint was easy to apply with a vision-based tool calibration and was chosen for a real world implementation. The TCP calibration method described in the disclosure above was implemented and tested using an industrial welding robot with a standard MIG welding gun. The tool calibration software was implemented on a separate computer, with communication to the robot controller occurring over standard communication link. With the aid of some short programs written for the robot, the calibration software was able to command the robot to move to the positions required. A black and white, digital camera was used, which was interfaced to the calibration software through a standard driver.

First the intrinsic calibration of the camera was performed using the self-calibration method with a checkerboard calibration pattern. The pattern was attached to a rigid metal plate to ensure its planar nature. Table 1 shows the calibrated intrinsic parameters of the camera. Because the camera is only used to ensure that the TCP's are at the same point in the image, it is not necessary to consider lens distortion for the TCP calibration application. Lens distortion is a more important issue when the camera is to be used for making accurate measurements over a large area in the image.

TABLE 1
Camera Intrinsic Parameters

| Parameter | Value |
|---|---|
| u-Axis Scale Factor | 2470.99 |
| v-Axis Scale Factor | 2468.27 |
| u-Axis Image Center | 533.05 |
| v-Axis Image Center | 368.26 |

After the intrinsic parameters of the camera were calibrated, the partial 3-D calibration procedure discussed in the Partial Three-Dimensional Camera Calibration section above was performed. A manual tool calibration was also carried out for the tool, using the software in the robot controller. The value of the TCP obtained through the manual method was (−125.96,−0.55,398.56)^{T}, measured in millimeters. The orientation of this particular tool was the same as the orientation of the wrist.

It is important to note that without specialized measuring equipment, it is impossible to determine the tool center point relative to the robot world-frame for comparison to the tool center point calculated by the invention as was done for the simulation discussed in the disclosure above. Computer Aided Design (CAD) models are inadequate representations of the real tool, and all of the tool calibration methods available have some error. Therefore, the analyses presented here used a rough vision-based measure of error to give an idea of the performance of the method.

In an attempt to assess the true accuracy of the automatic method compared to the manual method, a vision-based measure of error was applied. It may be observed that if the robot has an incorrect tool definition and the robot is then commanded to rotate about the TCP, the tip of the real tool will move in space by an amount related to the error in the tool definition. To measure this error, the tool is moved to an arbitrary starting location and the image coordinates of the TCP are recorded. The tool is then rotated about each axis of the tool-frame individually by some amount, and the image coordinates of the TCP are recorded after each rotation. The image coordinates of the TCP for the starting location is then subtracted from the recorded TCP's, and the norm of each of the three difference vectors is computed. The error measure is then defined as the sum of the norms of the difference vectors. Note that the error measurement does not provide specific information about the direction or real world magnitude of the error in the tool definition, but instead provides a quantity that is correlated to the magnitude of the true error.

To assess the validity of the error measurement, the error measurement was applied to a constant tool definition 30 times and the results were averaged. A plot showing the average error for the particular TCP and the standard deviation for the data was created. The standard deviation is the important result from the experiment because the standard deviation gives an idea of the reliability of the error measurement. The standard deviation was just over one pixel, which means that the errors found in subsequent experiments were probably within one or two pixels of the true error. The one or two pixel deviation is most likely due to the image processing algorithm, which does not return exactly the same result for the image TCP every time. However, a standard deviation of one pixel is considered acceptable and shows that the results obtained in the subsequent experiments are valid.

FIG. 13 is an illustration 1300 of a process to automatically generate wrist poses 1302 for a robot. One of the problems in automating the TCP method is choosing the wrist poses 1302 that will be used. For the real world experiment, a method was used that automatically generated a specified number of wrist poses 1302 whose origins lie on a sphere, and where a specified vector of interest 1304 in the wrist coordinate frame points toward the center of the sphere 1306. A parameter, called the envelope angle 1308, controlled the angle between the generated wrist poses 1302. The envelope angle 1309 has an effect on the accuracy and robustness of the tool calibration method. That is, if the difference between the wrist poses 1302 is too small, the problem becomes ill conditioned and the TCP calibration algorithm has numerical difficulties. However, the envelope angle 1308 parameter has an upper limit because a large envelope will cause the tool to exit the field of view of the camera. From experimentation, it was found that the minimum envelope angle 1308 for the tool calibration to work correctly was around seven degrees. Below seven degrees, the TCP calibration algorithm was unable to reliably determine the correct TCP. The envelope angle 1308 could be increased to 24 degrees before the tool was no longer in the field of view of the camera.

To measure the performance of the TCP calibration algorithm, the TCP was calculated at increasing envelope angles 1308 within the usable range. The average of three trials was taken, and the results were plotted. While the data was somewhat erratic, the plot still generally trended downward, which means that larger envelope angles 1308 do, in fact, reduce the error in the computation. In fact, increasing the envelope angle 1308 from ten to twenty degrees reduced the error by a factor of two. A conclusion from the real world experiment is that, in the interest of accuracy and consistency, it is better to use as large an angle as possible given the field of view of the camera, agreeing with the results obtained through simulation.

Given the real world experiment data, it is reasonable to conclude that an effective technique for increasing the accuracy of the TCP is to use a large envelope angle 1308 in order to maximize the difference between the wrist poses 1302. To avoid issues with the camera's field of view, the method could also be performed once with a small envelope angle 1308 to obtain a rough TCP, and then repeated with a large envelope angle 1308 to fine-tune the result.

The vision-based error measurement was also applied in order to compare the manually and automatically defined TCP's. The automatic method used four wrist poses with an envelope angle 1308 of twenty degrees. The TCP was defined ten times with each method (automatic and manual) to obtain a statistical distribution.

The average TCP's for each method (manual or automatic) are very similar, which means that the automatic method is capable of determining the correct TCP. The standard deviations for the automatic method are generally around 0.5 millimeters, which is a good result because the result indicates that the automatic method is consistent and reliable.

Table 2 shows the result of applying the error measurement to both the automatic TCP and the manually defined TCP. The errors in the automatic and manual methods are almost identical. This means that the automatic method does not offer an accuracy improvement over the manual method, but that it is capable of delivering comparable accuracy. While accuracy is an important factor, there are also other advantages to the automatic method.

TABLE 2
Vision-based error measure.

| | Best Error | Average Error |
|---|---|---|
| | (Pixels) | (Pixels) |
| Automatic TCP | 3.37 | 4.94 |
| Manual TCP | 3.35 | 4.53 |

One of the primary advantages of the visual tool-frame (TCP) calibration is speed. Even with a skilled operator, manual methods and some other automatic methods may take ten minutes to fully define an unknown tool, while the vision-based method yielded calibration times of less than one minute. Incorporating an initial approximation (i.e., guess) or increasing the robot's velocity between wrist poses 1302 may further reduce calibration time.

Various embodiments have been described for calibrating the tool-frame of a robot quickly and accurately without performing the full kinematic calibration. The accuracy of the vision-based TCP calibration method is comparable to other methods, and the techniques of the various embodiments provide an order of magnitude in speed improvement. The TCP computation method described herein is robust and flexible, and is capable of being used with any type of sensing system, vision-based or otherwise.

A challenging portion of this application is the vision system itself. Using vision in uncontrolled industrial environments can present a number of challenges, and the best algorithm in the world is useless if reliable data cannot be extracted from the image. A big problem for vision systems in industrial environments is the unpredictable and often hazardous nature of the environment itself. Therefore, the calibration systems must be robust and reliable, a task which is difficult to achieve. However, with careful use of robust image processing techniques, controlled backgrounds and lighting, reliable performance may be achieved.

The TCP calibration method of the various embodiments may be used in a wide variety of real world robot applications, including industrial robotic cells, as a fast and accurate method of keeping tool-frame definitions up to date in the robot controller. The speed of the various embodiments allows for a reduction in cycle times and/or more frequent tool calibrations, both of which may improve process quality overall and provide one more small step toward true offline programming.

Appendix A—Properties of Homogeneous Difference Matrices

Two homogeneous transformation matrices are defined as in Eq. 26.

$${W}_{1} = [ \begin{matrix}{R}_{1} & {T}_{1} \\ 0 & 1\end{matrix} ] \qquad Eq . 26$$

If the difference of the two homogenous matrices is taken, the result is obviously not a homogeneous transformation anymore, but still has some interesting properties that stem from the properties of the original matrices. The resulting homogeneous difference matrix may be expressed as in Eq. 27.

$${W}_{1} - {W}_{2} = ( \begin{matrix}{R}_{1} - {R}_{2} & {T}_{1} - {T}_{2} \\ 0 & 0\end{matrix} ) \qquad Eq . 27$$

The first interesting property of the homogeneous difference matrix may be stated as follows:
Property A1: The dimension of the null space of a homogeneous difference matrix resulting from subtracting two homogeneous transformation matrices is at least one.
   Proof: The last row of the homogeneous difference matrix in Eq. 27 is always zero, regardless of the original homogeneous transformation matrices, meaning that any vector whose only nonzero element is the last element will be mapped to zero by the difference matrix. Therefore the vector

(0 . . . 0 1)^{T}

is a basis vector for the null space, and the dimension of the null space is one.

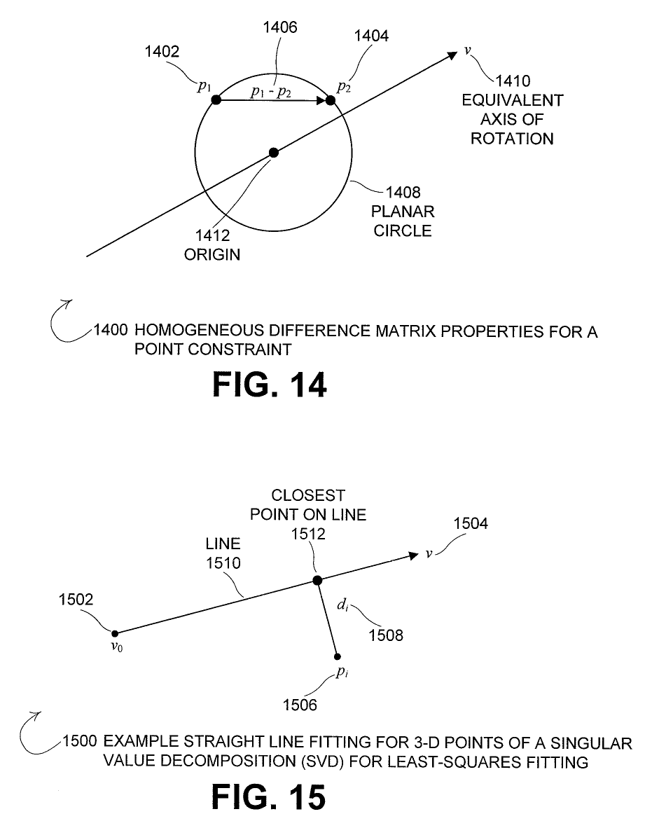

FIG. 14 is an illustration of homogenous difference matrix properties for a point constraint. A second important property is relevant to three-dimensional transformations (i.e., when the homogeneous transformation matrix is of size 4×4).
Property A2: The columns of the 3×3 matrix resulting from subtracting two three-dimensional rotation matrices are coplanar.
   Proof: Any 3-D rotation may be expressed in an angle-axis format, where points 1402, 1404 are rotated about a 3-D vector 1410 passing through the origin 1412, called the equivalent axis of rotation 1410. As the angle of rotation increases, any point 1402, 1404 moves in a circle 1408 about the equivalent axis of rotation 1410, meaning that the vector 1408 between the old point 1402 and the new rotated point 1404 is perpendicular to the equivalent axis of rotation 1410.

In the illustration 1400, p₁-p₂ 1406 is perpendicular to v 1410. The perpendicular nature of the difference vector 1406 is true of the difference vector 1406 between any point 1402 and the new rotated location 1404 of the point, meaning that subtracting two rotation matrices results in a new matrix consisting of the vectors between points on the old coordinate axes and points on the new coordinate axes. The difference vectors 1406 are coplanar, according to the argument given above. In fact, the difference vectors 1406 are contained in the plane whose normal is the equivalent axis of rotation 1410. One of the implications of the perpendicular property of the difference vectors 1406 is that only two of the three vectors in the difference of two rotation matrices are linearly independent. In fact, it turns out that only two of the columns in a three-dimensional homogeneous difference matrix are linearly independent (see the Tool-Frame Cal. Stage 1: Calibrating the Tool Center Point (TCP) section above).

Appendix B—SVD for Least-Squares Fitting

FIG. 15 is an illustration 1500 of an example straight line fitting for three-dimensional points of a Singular Value Decomposition (SVD for least-squares fitting. The singular value decomposition provides an elegant way to compute the line or plane of best fit for a set of points, in a least-squares sense. While it is possible to solve the best fit problem by directly applying the least-squares method in a more traditional sense, using the SVD gives a consistent method for line and plane fitting in both 2-D and 3-D space without the need for complicated and separate equations for each case.

For example, suppose a straight line 1510 is to be fitted to a set of 3-D points. Let pᵢ 1506 be the i^{th} point in a data set that contains n points. Let v₀ 1502 be a point on the line, and let v 1504 be a unit vector in the direction of the line. A parametric equation (Eq. 28) may be written for the line 1510, based on the point v₀ 1502 and the vector v 1504:

pᵢ=αᵢv+v₀ Eq. 28

The distance 1508 between a point 1506 and a line 1510 is usually defined as the distance 1508 between the point 1506 and the closest point 1508 on the line 1510. The value of αᵢ may be found for the point 1512 on the line 1510 that is closest tops 1506, which yields an Eq. 29 for the distance dᵢ 1508.

dᵢ²=∥v₀+(pᵢ−v₀)^{T}v·v−p₁∥² Eq. 29

If d 1508 is considered to be the i^{th} error in the line fit, a least-squares technique may be applied to find the line that minimizes the Euclidean norm of the error, denoted ε, which amounts to finding v₀ 1502 and v 1510 that solve the following optimization problem of Eq. 30.

$$\begin{matrix}{min ( ɛ )}^{2} = min {\sum }_{i = 1}^{n} {d}^{2} \\ = min {\sum }_{i = 1}^{n} {‖ {v}_{0} + {( {p}_{i} - {v}_{0} )}^{T} v \cdot v - {p}_{i} ‖}^{2}\end{matrix} \qquad Eq . 30$$

For simplicity, define qᵢ with Eq. 31.

qᵢ=pᵢ−v₀ Eq. 31

Then plug qᵢ into the objective function and expand to obtain Eq. 32.

$$\begin{matrix}{min ( ɛ )}^{2} = min {\sum }_{i = 1}^{n} {‖ ( {q}_{i}^{T} v ) \cdot v - {q}_{i} ‖}^{2} \\ = min {\sum }_{i = 1}^{n} {( ( {q}_{i}^{T} v ) \cdot v - {q}_{i} )}^{T} ( ( {q}_{i}^{T} v ) \cdot v - {q}_{i} ) \\ = min {\sum }_{i = 1}^{n} ( {( {q}_{i}^{T} v )}^{2} ( {v}^{T} v ) - 2 {( {q}_{i}^{T} v )}^{2} + {q}_{i}^{2} ) \\ = min {\sum }_{i = 1}^{n} ( - {( {q}_{i}^{T} v )}^{2} ) + min {\sum }_{i = 1}^{n} ( {q}_{i}^{2} ) .\end{matrix} \qquad Eq . 32$$

The first term in the minimization problem above may be re-written as a maximization problem, as in Eq. 33.

$$min {\sum }_{i = 1}^{n} - {( {q}_{i}^{T} v )}^{2} = max {\sum }_{i = 1}^{n} {( {q}_{i}^{T} v )}^{2} \qquad Eq . 33$$

Now, the sum of Eq. 33 may be rewritten as Eq. 34 using the norm of a matrix Q, which is composed of the individual components of the qᵢ's.

$$\begin{matrix}{\sum }_{i = 1}^{n} {( {q}_{i}^{T} v )}^{2} = ‖ Qv ‖ \\ where & Eq . 34 \\ Q = ( \begin{matrix}{q}_{1}^{T} \\ ⋮ \\ {q}_{n}^{T}\end{matrix} ) = ( \begin{matrix}{q}_{1 x} & {q}_{1 y} & {q}_{1 z} \\ ⋮ & ⋮ & ⋮ \\ {q}_{nx} & {q}_{ny} & {q}_{nz}\end{matrix} ) & Eq . 35\end{matrix}$$

So the final optimization problem is given by Eq. 36.

max∥Qv∥ Eq. 36

In the singular value decomposition of Q, the maximum singular value corresponds to the maximum scaling of the matrix in any direction. Therefore, because Q is constant, the objective function of the maximization problem is at a maximum when v 1510 is along the singular direction of Q corresponding to the maximum singular value of Q. Because all of the pᵢ's 1506 are translated equally by the choice of v₀ 1502, the choice of v₀ 1502 does not change the SVD of Q.

For the second term in Eq. 32, in order for the sum of qᵢ² to be a minimum v₀ 1502 must be the centroid of the points because the centroid is the point that is closest to all of the data points, in a least-squares sense. Any other choice of v₀ 1502 would result in a larger value for the second term in Eq. 32.

Using the SVD in as described above may be applied to 2-D and 3-D lines, as well as 3-D planes. First the centroid is computed, which is a point on the line or plane. Then the singular direction corresponding to the maximum singular value of Q is computed. In the line case, the direction is a unit vector 1504 in the direction of the line 1510. In the plane case, the vector lies in the plane. For the plane case, the singular direction corresponding to the minimum singular value is the normal, which is a more convenient way of dealing with planes.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for vision-based calibration of a tool-frame for a tool attached to a robot using a camera comprising:
providing said robot, said robot having a wrist that is moveable, said robot having a control system that moves said robot and said wrist into different poses, said tool attached to said robot being at different orientations for said different poses, said robot control system defining a wrist-frame for said wrist of said robot such that said robot control system knows a position and an orientation of said wrist for said different poses via a kinematic model of said robot;
providing said camera, said camera being mounted external of said robot, said camera capturing an image of said tool;
designating a point on said tool in said image of said tool as an image tool center point of said tool, said image tool center point being a point on said tool that is desired to be an origin of said tool-frame for said kinematic model of said robot;
moving said robot into a plurality of wrist poses, each wrist pose of said plurality of wrist poses being constrained such that said image tool center point of said tool is located within a specified geometric constraint in said image captured by said camera;
calculating a tool-frame tool center point relative to said wrist-frame of said wrist of said robot for said tool as a function of said specified geometric constraint and also as a function of said position and said orientation of said wrist of said robot for each wrist pose of said plurality of wrist poses;
defining said tool-frame of said tool relative to said wrist-frame for said kinematic model of said robot as said tool-frame tool center point; and,
operating said robot to perform desired tasks with said tool using said kinematic model of said robot with said defined tool-frame.

2. The method of claim 1 further comprising:
finding a tool orientation of said tool with respect to said wrist-frame;
refining said tool-frame of said tool relative to said wrist-frame for said kinematic model of said robot as a function of said tool-frame tool center point and said tool orientation; and,
operating said robot to perform desired tasks with said tool using said kinematic model of said robot with said refined tool-frame.

3. The method of claim 2 wherein said process of finding said tool orientation of said tool with respect to said wrist-frame further comprises:
designating a second orientation point on said tool in said image of said tool as a secondary image tool orientation point of said tool;
moving said robot into a second plurality of tool orientation wrist poses, each tool orientation wrist pose of said second plurality of tool orientation of wrist poses being constrained such that said image tool orientation point of said tool is located within a second tool orientation specified geometric constraint in said image captured by said camera;
calculating a tool-frame second orientation point relative to said wrist-frame of said wrist of said robot for said tool as a function of said a second tool orientation specified geometric constraint and also as a function of said position and said orientation of said wrist of said robot for each tool orientation wrist pose of said second plurality of tool orientation wrist poses;
designating a tool direction vector as a vector disposed from said tool-frame second orientation point to said tool-frame tool center point; and,
calculating a tool orientation as a function of said tool direction vector.

4. The method of claim 2 wherein said tool is a two-wire welding torch that has two wires, a front wire and a back wire, and further comprising:
rotating and tilting said two-wire welding torch tool with said wrist of said robot to an operation direction wrist pose, said operation direction wrist pose being achieved when said wrist is rotated and tilted such that said front wire eclipses said back wire in said image captured by said camera so that said two-wire welding torch tool appears to have a single wire in said image capture by said camera;
calculating a tool operation direction relative to said wrist-frame as a function of said position and said orientation of said wrist of said robot for said operation direction wrist pose;
refining further said tool-frame of said tool relative to said wrist-frame for said kinematic model of said robot as a function of said tool-frame tool center point, said tool orientation, and said tool operation direction; and,
operating said robot to perform desired tasks with said tool using said kinematic model of said robot with said further refined tool-frame.

5. The method of claim 1 wherein said process of moving said robot into a plurality of wrist poses further comprises:
adjusting each wrist pose of said plurality of wrist poses until said image tool center point of said tool appearing in said image of said camera is located within said specified geometric constraint.

6. The method of claim 1 wherein said process of moving said robot into a plurality of wrist poses further comprises:
obtaining a correction measurement for said image tool center point for each wrist pose of said plurality of wrist poses by measuring a change in coordinates necessary to move said image tool center point in said image as observed by said camera to a location that satisfies said specified geometric constraint; and,
updating said position and said orientation for each wrist pose of said plurality of wrist poses to account for said correction measurement obtained for each wrist pose of said plurality of wrist poses.

7. The method of claim 1 wherein said specified geometric constraint is a point constraint.

8. The method of claim 7 wherein said plurality of wrist poses comprises at least three wrist poses to supply sufficient data for said process of calculating said tool-frame tool center point relative to said wrist pose.

9. The method of claim 1 wherein said specified geometric constraint is a line constraint.

10. The method of claim 9 wherein said plurality of wrist poses comprises at least four wrist poses to supply sufficient data for said process of calculating said tool-frame tool center point relative to said wrist pose.

11. The method of claim 1 wherein said plurality of wrist poses comprises a large number of wrist poses in order to reduce errors in said process of calculating said tool-frame tool center point caused by inaccuracy in measurements of each wrist pose of said plurality of wrist poses, said large number of wrist poses being substantively larger than a minimum number of wrist poses needed for said process of calculating said tool-frame tool center point relative to said wrist pose to calculate said tool-frame tool center point.

12. The method of claim 11 wherein said large number of wrist poses is at least thirty wrist poses.

13. The method of claim 1 further comprising:
calibrating said camera to correlate locations on said image captured by said camera with said kinematic model of said robot.

14. The method of claim 13 wherein said process of calibrating said camera performs a simplified extrinsic rotational calibration process to compute extrinsic rotational parameters between said camera and a world-frame of said kinematic model of said robot without performing other intrinsic and extrinsic camera parameter calculations.

15. The method of claim 1 wherein said image tool center point is located on said image captured by said camera by a tool center point extraction process comprising:
thresholding said image captured by said camera to produce a thresholded image;
computing a convex hull from said thresholded image in order to segment said image;
finding a rough orientation of said tool by fitting an ellipse over said convex hull;
refining said rough orientation of said tool to a refined orientation of said tool by searching for sides of said tool in said image captured by said camera;
searching for said image tool center point of said tool by performing searches perpendicular to said sides of said tool until an end of said tool is located and locating said image tool center point based on a geometry of said tool.

16. A vision-based robot calibration system for calibrating a tool-frame for a tool attached to a robot using a camera comprising:
said robot, said robot having a wrist that is moveable, said robot having a control system that moves said robot and said wrist into different poses, said tool attached to said robot being at different orientations for said different poses, said robot control system defining a wrist-frame for said wrist of said robot such that said robot control system knows a position and an orientation of said wrist for said different poses via a kinematic model of said robot;
said camera, said camera being mounted external of said robot, said camera capturing an image of said tool;
a wrist pose sub-system that designates a point on said tool in said image of said tool as an image tool center point of said tool and moves said robot into a plurality of wrist poses, said image tool center point being a point on said tool that is desired to be an origin of said tool-frame for said kinematic model of said robot, each wrist pose of said plurality of wrist poses being constrained such that said image tool center point of said tool is located within a specified geometric constraint in said image captured by said camera;
a tool center point calculation sub-system that calculates a tool-frame tool center point relative to said wrist-frame of said wrist of said robot for said tool as a function of said specified geometric constraint and also as a function of said position and said orientation of said wrist of said robot for each wrist pose of said plurality of wrist poses;
a robot kinematic incorporation subsystem that defines said tool-frame of said tool relative to said wrist-frame for said kinematic model of said robot as said tool-frame tool center point.

17. The vision-based robot calibration system of claim 1 further comprising:
a tool orientation subsystem that finds a tool orientation of said tool with respect to said wrist-frame; and
wherein said robot kinematic incorporation subsystem refines said tool-frame of said tool relative to said wrist-frame for said kinematic model of said robot as a function of said tool-frame tool center point and said tool orientation.

18. The vision-based robot calibration system of claim 17 wherein said tool orientation subsystem further comprises:
a secondary wrist pose sub-system that designates a second orientation point on said tool in said image of said tool as a secondary image tool orientation point of said tool and moves said robot into a second plurality of tool orientation wrist poses, each tool orientation wrist pose of said second plurality of tool orientation of wrist poses being constrained such that said image tool orientation point of said tool is located within a second tool orientation specified geometric constraint in said image captured by said camera;
a tool orientation point calculation sub-system that calculates a tool-frame second orientation point relative to said wrist-frame of said wrist of said robot for said tool as a function of said a second tool orientation specified geometric constraint and also as a function of said position and said orientation of said wrist of said robot for each tool orientation wrist pose of said second plurality of tool orientation wrist poses; and
a tool orientation sub-system that designates a tool direction vector as a vector disposed from said tool-frame orientation point to said tool-frame tool center point and calculates a tool orientation as a function of said tool direction vector.

19. The vision-based robot calibration system of claim 17 wherein said tool is a two-wire welding torch that has two wires, a front wire and a back wire, and further comprising:
a two wire direction finding sub-system that rotates and tilts said two-wire welding torch tool with said wrist of said robot to an operation direction wrist pose, said operation direction wrist pose being achieved when said wrist is rotated and tilted such that said front wire eclipses said back wire in said image captured by said camera so that said two-wire welding torch tool appears to have a single wire in said image capture by said camera; and,
a tool operation direction calculation sub-system that calculates a tool operation direction relative to said wrist-frame as a function of said position and said orientation of said wrist of said robot for said operation direction wrist pose; and,
wherein said robot kinematic incorporation sub-system further refines said tool-frame of said tool relative to said wrist-frame for said kinematic model of said robot as a function of said tool-frame tool center point, said tool orientation, and said tool operation direction.

20. The vision-based robot calibration system of claim 16 wherein said wrist pose sub-system further adjusts each wrist pose of said plurality of wrist poses until said image tool center point of said tool appearing in said image of said camera is located within said specified geometric constraint.

21. The vision-based robot calibration system of claim 16 wherein said wrist pose sub-system further obtains a correction measurement for said image tool center point for each wrist pose of said plurality of wrist poses by measuring a change in coordinates necessary to move said image tool center point in said image as observed by said camera to a location that satisfies said specified geometric constraint and updates said position and said orientation for each wrist pose of said plurality of wrist poses to account for said correction measurement obtained for each wrist pose of said plurality of wrist poses.

22. The vision-based robot calibration system of claim 16 wherein said specified geometric constraint is a point constraint.

23. The vision-based robot calibration system of claim 22 wherein said plurality of wrist poses comprises at least three wrist poses to supply sufficient data for said tool center point calculation sub-system.

24. The vision-based robot calibration system of claim 16 wherein said specified geometric constraint is a line constraint.

25. The vision-based robot calibration system of claim 24 wherein said plurality of wrist poses comprises at least four wrist poses to supply sufficient data for said tool center point calculation sub-system.

26. The vision-based robot calibration system of claim 1 wherein said plurality of wrist poses comprises a large number of wrist poses in order to reduce errors in said process of calculating said tool-frame tool center point caused by inaccuracy in measurements of each wrist pose of said plurality of wrist poses, said large number of wrist poses being substantively larger than a minimum number of wrist poses needed for said process of calculating said tool-frame tool center point relative to said wrist pose to calculate said tool-frame tool center point.

27. The vision-based robot calibration system of claim 26 wherein said large number of wrist poses is at least thirty wrist poses.

28. The vision-based robot calibration system of claim 16 further comprising:
a camera calibration sub-system that calibrates said camera to correlate locations on said image captured by said camera with said kinematic model of said robot.

29. The vision-based robot calibration system of claim 28 wherein said camera calibration sub-system performs a simplified extrinsic rotational calibration process to compute extrinsic rotational parameters between said camera and a world-frame of said kinematic model of said robot without performing other intrinsic and extrinsic camera parameter calculations.

30. The vision-based robot calibration system of claim 16 further comprising an image tool center point sub-system as part of said wrist pose sub-system for locating said image tool center point on said image captured by said camera comprising:
an image segmenting sub-system that thresholds said image captured by said camera to produce a thresholded image and computes a convex hull from said thresholded image;
a rough orientation sub-system that finds a rough orientation of said tool by fitting an ellipse over said convex hull;
a refined orientation sub-system that refines said rough orientation of said tool to a refined orientation of said tool by searching for sides of said tool in said image captured by said camera; and,
an image TCP location sub-system that searches for said image tool center point of said tool by performing searches perpendicular to said sides of said tool until an end of said tool is located and locates said image tool center point based on a geometry of said tool.

31. A vision-based robot calibration system for calibrating a tool-frame for a tool attached to a robot using a camera comprising:
means for providing said robot, said robot having a wrist that is moveable, said robot having a control system that moves said robot and said wrist into different poses, said robot control system defining a wrist-frame for said wrist of said robot such that said robot control system knows a position and an orientation of said wrist for said different poses via a kinematic model of said robot;
means for providing said camera, said camera being mounted external of said robot, said camera capturing an image of said tool;
means for designating a point on said tool in said image of said tool as an image tool center point of said tool;
means for moving said robot into a plurality of wrist poses, each wrist pose of said plurality of wrist poses being constrained such that said image tool center point of said tool is located within a specified geometric constraint in said image captured by said camera;
means for calculating a tool-frame tool center point relative to said wrist-frame of said wrist of said robot for said tool as a function of said specified geometric constraint and also as a function of said position and said orientation of said wrist of said robot for each wrist pose of said plurality of wrist poses;
means for defining said tool-frame of said tool relative to said wrist-frame for said kinematic model of said robot as said tool-frame tool center point; and,
means for operating said robot to perform desired tasks with said tool using said kinematic model of said robot with said defined tool-frame.

32. A computerized method for calculating a tool-frame tool center point relative to a wrist-frame of a robot for a tool attached at a wrist of said robot using a camera comprising:
providing a computer system for running computer software, said computer system having at least one computer readable storage medium for storing data and computer software;
mounting said camera external of said robot;
operating said camera to capture an image of said tool;
defining a point on a geometry of said tool as a tool center point of said tool;
defining a constraint region on said image captured by said camera;
moving said robot into a plurality of wrist poses, each wrist pose of said plurality of wrist poses having a known position and orientation within a kinematic model of said robot; each wrist pose of said plurality of wrist poses having a different position and orientation from other wrist poses of said plurality of wrist poses;
analyzing said image captured by said camera with said computer software to locate said tool center point of said tool in said image for each wrist pose of said plurality of wrist poses;
correcting said position and orientation of each wrist pose of said plurality of wrist poses using said camera such that said tool center point of said tool located in said image captured by said camera is constrained within said constraint region defined for said image;
calculating a tool-frame tool center point relative to said wrist-frame of said robot with said computer software as a function of said position and orientation of each wrist pose of said plurality of wrist poses as corrected to constrain said tool center point in said image to said constraint region on said image;
updating said kinematic model of said robot with said computer software to incorporate said tool-frame tool center point relative to said wrist-frame of said robot as an origin of said tool-frame of said tool within said kinematic model of said robot; and,
operating said robot using said kinematic model as updated to incorporate said tool-frame tool center point to perform desired tasks with said tool.

33. The computerized method of claim 32 further comprising:
storing on said image on said at least one computer readable storage medium said wrist pose position and orientation for each wrist pose of said plurality of wrist poses as corrected to constrain said tool center point in said image to said constraint region.

34. The computerized method of claim 32 further comprising:
defining a second point on said geometry of said tool in said image of said tool as a secondary tool orientation point of said tool;
defining a tool orientation constraint region on said image captured by said camera;
moving said robot into a second plurality of tool orientation wrist poses, each tool orientation wrist pose of said second plurality of tool orientation wrist poses having a known position and orientation within a kinematic model of said robot; each tool orientation wrist pose of said second plurality of tool orientation wrist poses having a different position and orientation from other tool orientation wrist poses of said second plurality of tool orientation wrist poses;
analyzing said image captured by said camera with said computer software to locate said tool secondary tool orientation point of said tool in said image for each tool orientation wrist pose of said plurality of tool orientation wrist poses;
correcting said position and orientation of each tool orientation wrist pose of said second plurality of tool orientation wrist poses using said camera such that said tool secondary tool orientation point of said tool located in said image captured by said camera is constrained within said tool orientation constraint region defined for said image;
calculating a tool-frame secondary tool orientation point relative to said wrist-frame of said robot with said computer software as a function of said position and orientation of each tool orientation wrist pose of said second plurality of tool orientation wrist poses as corrected to constrain said secondary tool orientation point in said image to said tool orientation constraint region on said image;
calculating a tool direction vector as a vector disposed from said tool-frame secondary tool orientation point to said tool-frame tool center point;
calculating a tool orientation as a function of said tool direction vector;
updating said kinematic model of said robot with said computer software to incorporate said tool orientation relative to said wrist-frame of said robot; and,
operating said robot using said kinematic model as updated to incorporate said tool-frame tool orientation to perform desired tasks with said tool.

35. The computerized method of claim 34 wherein said tool is a two-wire welding torch that has two wires, a front wire and a back wire, and further comprising:
rotating and tilting said two-wire welding torch tool with said wrist of said robot to an operation direction wrist pose, said operation direction wrist pose being achieved when said wrist is rotated and tilted such that said front wire eclipses said back wire in said image captured by said camera so that said two-wire welding torch tool appears to have a single wire in said image captured by said camera;
calculating a tool operation direction relative to said wrist-frame as a function of said position and orientation of said wrist of said robot for said operation direction wrist pose;
updating said tool-frame of said tool relative to said wrist-frame for said kinematic model of said robot further to incorporate said tool operation direction; and,
operating said robot using said kinematic model as updated to incorporate said tool operation direction to perform desired tasks with said tool.

36. The computerized method of claim 32 wherein said process of correcting said position and orientation of each wrist pose of said plurality of wrist poses further comprises:
adjusting each wrist pose of said plurality of wrist poses until said tool center point of said tool appearing in said image captured by said camera is located within said constraint region on said image.

37. The computerized method of claim 32 wherein said process of correcting said position and orientation of each wrist pose of said plurality of wrist poses further comprises:
obtaining a correction measurement for said tool center point for each wrist pose of said plurality of wrist poses by measuring a change in coordinates necessary to move said image tool center point in said image as observed by said camera to a location within said constraint region on said image; and,
updating said position and orientation for each wrist pose of said plurality of wrist poses to account for said correction measurement obtained for each wrist pose of said plurality of wrist poses.

38. The computerized method of claim 32 wherein said plurality of wrist poses are automatically generated.

39. The computerized method of claim 32 further comprising:
performing a simplified extrinsic rotational calibration process to compute extrinsic rotational parameters between said camera and a world-frame of said kinematic model of said robot without performing other intrinsic and extrinsic camera parameter calculations in order to calibrate said camera to correlate locations on said image captured by said camera with said kinematic model of said robot.

40. A computerized calibration system for calculating a tool-frame tool center point relative to a wrist-frame of a robot for a tool attached at a wrist of said robot using an externally mounted camera comprising:
a computer system that runs computer software, said computer system having at least one computer readable storage medium for storing data and computer software;
operating said camera to capture an image of said tool;
a constraint definition sub-system that defines a point on a geometry of said tool as a tool center point of said tool and defines a constraint region on said image captured by said camera;
a wrist pose sub-system that moves said robot into a plurality of wrist poses, each wrist pose of said plurality of wrist poses having a known position and orientation within a kinematic model of said robot; each wrist pose of said plurality of wrist poses having a different position and orientation from other wrist poses of said plurality of wrist poses;
an image analysis sub-system that analyzes said image captured by said camera with said computer software to locate said tool center point of said tool in said image for each wrist pose of said plurality of wrist poses;
a wrist pose correction sub-system that corrects said position and orientation of each wrist pose of said plurality of wrist poses using said camera such that said tool center point of said tool located in said image captured by said camera is constrained within said constraint region defined for said image;
a tool-frame tool center point calculation sub-system that calculates a tool-frame tool center point relative to said wrist-frame of said robot with said computer software as a function of said position and orientation of each wrist pose of said plurality of wrist poses as corrected to constrain said tool center point in said image to said constraint region on said image; and,
a kinematic model update sub-system that updates said kinematic model of said robot with said computer software to incorporate said tool-frame tool center point relative to said wrist-frame of said robot as an origin of said tool-frame of said tool within said kinematic model of said robot.

41. The computerized calibration system of claim 40 wherein said wrist pose position and orientation for each wrist pose of said plurality of wrist poses as corrected to constrain said tool center point in said image to said constraint region on said image is stored on said at least one computer readable storage medium.

42. The computerized calibration system of claim 40 further comprising:
a secondary constraint sub-system that defines a second point on said geometry of said tool in said image of said tool as a secondary tool orientation point of said tool and defines a tool orientation constraint region on said image captured by said camera;
a secondary wrist pose sub-system that moves said robot into a second plurality of tool orientation wrist poses, each tool orientation wrist pose of said second plurality of tool orientation wrist poses having a known position and orientation within a kinematic model of said robot; each tool orientation wrist pose of said second plurality of tool orientation wrist poses having a different position and orientation from other tool orientation wrist poses of said second plurality of tool orientation wrist poses;
a secondary image analysis system that analyzes said image captured by said camera with said computer software to locate said tool secondary tool orientation point of said tool in said image for each tool orientation wrist pose of said plurality of tool orientation wrist poses;
a secondary wrist pose correction sub-system that corrects said position and orientation of each tool orientation wrist pose of said second plurality of tool orientation wrist poses using said camera such that said tool secondary tool orientation point of said tool located in said image captured by said camera is constrained within said tool orientation constraint region defined for said image;
a tool-frame secondary tool orientation point calculation sub-system that calculates a tool-frame secondary tool orientation point relative to said wrist-frame of said robot with said computer software as a function of said position and orientation of each tool orientation wrist pose of said second plurality of tool orientation wrist poses as corrected to constrain said secondary tool orientation point in said image to said tool orientation constraint region on said image;
a tool orientation calculation sub-system that calculates a tool direction vector as a vector disposed from said tool-frame secondary tool orientation point to said tool-frame tool center point and calculates a tool orientation as a function of said tool direction vector; and,
wherein said kinematic model update sub-system further updates said kinematic model of said robot with said computer software to incorporate said tool orientation relative to said wrist-frame of said robot.

43. The computerized calibration system of claim 42 wherein said tool is a two-wire welding torch that has two wires, a front wire and a back wire, and further comprising:
calculating a tool operation direction relative to said wrist-frame as a function of said position and said orientation of said wrist of said robot for said operation direction wrist pose;
updating said tool-frame of said tool relative to said wrist-frame for said kinematic model of said robot further to incorporate said tool operation direction; and,
operating said robot using said kinematic model as updated to incorporate said tool operation direction to perform desired tasks with said tool.
a two wire direction finding sub-system that rotates and tilts said two-wire welding torch tool with said wrist of said robot to an operation direction wrist pose, said operation direction wrist pose being achieved when said wrist is rotated and tilted such that said front wire eclipses said back wire in said image captured by said camera so that said two-wire welding torch tool appears to have a single wire in said image capture by said camera; and,
a tool operation direction calculation sub-system that calculates a tool operation direction relative to said wrist-frame as a function of said position and orientation of said wrist of said robot for said operation direction wrist pose; and,
wherein said kinematic model update sub-system further updates said kinematic model of said robot with said computer software to incorporate said tool operation direction relative to said wrist-frame of said robot.

44. The computerized calibration system of claim 40 wherein said wrist pose correction sub-system corrects each wrist pose of said plurality of wrist poses by adjusting each wrist pose of said plurality of wrist poses until said tool center point of said tool appearing in said image captured by said camera is located within said constraint region on said image.

45. The computerized calibration system of claim 40 wherein said wrist pose correction sub-system corrects each wrist pose of said plurality of wrist poses by obtaining a correction measurement for said tool center point for each wrist pose of said plurality of wrist poses by measuring a change in coordinates necessary to move said image tool center point in said image as observed by said camera to a location within said constraint region on said image, and, updating said position and orientation for each wrist pose of said plurality of wrist poses to account for said correction measurement obtained for each wrist pose of said plurality of wrist poses.

46. The computerized calibration system of claim 40 wherein said plurality of wrist poses are automatically generated.

47. The computerized calibration system of claim 40 further comprising:
a camera calibration sub-system that performs a simplified extrinsic rotational calibration process to compute extrinsic rotational parameters between said camera and a world-frame of said kinematic model of said robot without performing other intrinsic and extrinsic camera parameter calculations in order to calibrate said camera to correlate locations on said image captured by said camera with said kinematic model of said robot.

48. A robot calibration system that finds a tool-frame tool center point relative to a wrist-frame of a tool attached to a robot using an externally mounted camera comprising a computer system programmed to:
analyze an image captured by said externally mounted camera to locate a point on said tool in said image designated as an image tool center point of said tool for each wrist pose of a plurality of wrist poses of said robot, each wrist pose of said plurality of wrist poses being constrained such that said image tool center point is constrained within a geometric constraint region on said image, each wrist pose of said plurality of wrist poses having a known position and orientation within a kinematic model of said robot, each wrist pose of said plurality of wrist poses having a different position and orientation within said kinematic model of said robot from other wrist poses of said plurality of wrist poses;
calculate said tool-frame tool center point relative to said wrist-frame of said robot as a function of said position and orientation of each wrist pose of said plurality of wrist poses;
update said kinematic model of said robot to incorporate said tool-frame tool center point relative to said wrist-frame of said robot as an origin of said tool-frame of said tool within said kinematic model of said robot; and,
deliver said updated kinematic model of said robot to said robot such that said robot operates using said updated kinematic model to perform desired tasks with said tool attached to said robot.

49. The robot calibration system of claim 48 wherein said computer program is further programmed to:
correct said position and orientation of each wrist pose of said plurality of wrist poses using said camera such that said tool center point of said tool located in said image captured by said camera is constrained within said constraint region defined for said image

50. The robot calibration system of claim 48 wherein said computer program is further programmed to:
analyze an image captured by said externally mounted camera to locate a second point on said tool in said image designated as an image secondary tool orientation point of said tool for each tool orientation wrist pose of a second plurality of tool orientation wrist poses of said robot, each tool orientation wrist pose of said second plurality of tool orientation wrist poses being constrained such that said image secondary tool orientation point is constrained within a tool orientation geometric constraint region on said image, each tool orientation wrist pose of said second plurality of tool orientation wrist poses having a known position and orientation within a kinematic model of said robot, each tool orientation wrist pose of said second plurality of tool orientation wrist poses having a different position and orientation within said kinematic model of said robot from other tool orientation wrist poses of said second plurality of tool orientation wrist poses;
calculate a tool-frame secondary tool orientation point relative to said wrist-frame of said robot as a function of said position and orientation of each tool orientation wrist pose of said second plurality of tool orientation wrist poses;
calculate a tool direction vector as a vector disposed from said tool-frame secondary tool orientation point to said tool-frame tool center point;
calculate a tool orientation as a function of said tool direction vector;
update said kinematic model of said robot to incorporate said tool orientation relative to said wrist-frame of said robot; and,
deliver said updated kinematic model of said robot to said robot such that said robot operates using said updated kinematic model to perform desired tasks with said tool attached to said robot.

51. The robot calibration system of claim 50 wherein said tool is a two-wire welding torch that has two wires, a front wire and a back wire, and wherein said computer program is further programmed to:
rotate and tilt said two-wire welding torch tool with said wrist of said robot to an operation direction wrist pose, said operation direction wrist pose being achieved when said wrist is rotated and tilted such that said front wire eclipses said back wire in said image captured by said camera so that said two-wire welding torch tool appears to have a single wire in said image captured by said camera;
calculate a tool operation direction relative to said wrist-frame as a function of said position and said orientation of said wrist of said robot for said operation direction wrist pose;
update said tool-frame of said tool relative to said wrist-frame for said kinematic model of said robot further to incorporate said tool operation direction; and,
deliver said updated kinematic model of said robot to said robot such that said robot operates using said updated kinematic model to perform desired tasks with said tool attached to said robot.

52. The robot calibration system of claim 48 wherein said computer program is further programmed to:
perform a simplified extrinsic rotational calibration process to compute extrinsic rotational parameters between said camera and a world-frame of said kinematic model of said robot without performing other intrinsic and extrinsic camera parameter calculations in order to calibrate said camera to correlate locations on said image captured by said camera with said kinematic model of said robot.
